(19) United States
(12) Patent Application Publication
(10) Pub. No.: US 2026/0254619 A1
(43) Pub. Date: Aug. 27, 2026

(54) SYSTEMS AND METHODS FOR CROSS-DOMAIN AUTHENTICATION IN EDGE-ENABLED VEHICLE-TO-EVERYTHING (V2X) SERVICES

(71) Applicants: Xuemin Shen, Waterloo (CA); Lingshuang Liu, Kingston (CA); Dongxiao Liu, Jiaozuo City (CN); Cheng Huang, Shanghai (CN); Weihua Zhuang, Waterloo (CN); Huawei Technologies Canada Co., Ltd., Ottawa (CA)

(72) Inventors: Xuemin Shen, Waterloo (CA); Lingshuang Liu, Kingston (CA); Dongxiao Liu, Jiaozuo City (CN); Cheng Huang, Shanghai (CN); Weihua Zhuang, Waterloo (CA); Bidi Ying, Ottawa (CA)

(21) Appl. No.: 19/649,960

(22) Filed: Apr. 16, 2026

Related U.S. Application Data
(63) Continuation of application No. PCT/CA2023/051380, filed on Oct. 18, 2023.

(51) Int. Cl. H04L 9/08; H04L 9/30; H04L 9/32

(52) U.S. Cl. CPC H04L 9/0825; H04L 9/0869; H04L 9/3073; H04L 9/3218; H04L 9/3236; H04L 9/3247

(57) ABSTRACT

Apparatus, methods and systems for cross-domain authentication in edge-enabled vehicle-to-everything (V2X) services may be provided according to one or more aspects. According to an aspect, a method for generating identity credential may be provided. The method may include receiving, by an identity server (IS) from a user, a request for an identity credential, C_{id}. The request may include an identifier (ID) of the user, a commitment parameter C generated based on two random values r and v, a parameter T generated based on two random values a and t, and a proof transcript indicating ownership of r and v. The method may further include generating, by the IS, a signature σ′ based on the commitment C and a random value u. The method may further include sending, by the IS to the user, the generated signature σ′ usable by the user to obtain the identity credential C_{id}.

### CROSS-REFERENCE TO RELATED APPLICATION

This application is a continuation of International Application No. PCT/CA2023/051380, filed on Oct. 18, 2023, the disclosure of which is hereby incorporated by reference in its entirety.

### TECHNICAL FIELD

The present disclosure pertains to the field of connected vehicle security, and in particular to systems and methods for cross-domain authentication in edge-enabled vehicle-to-everything (V2X) services.

### BACKGROUND

Vehicle-to-Everything (V2X) technology holds significant promise in revolutionizing transportation by providing for potentially seamless communication between vehicles, infrastructure, and pedestrians. This technology has the potential to significantly enhance road safety, traffic efficiency, and overall driving experience. However, as V2X technology gains traction, the importance of security in its implementation becomes increasingly evident. With a growing number of vehicles relying on V2X communication, there is a corresponding surge in cyberattacks targeting these connections. Consequently, there is an urgent need for robust security measures to guarantee the integrity, privacy, and reliability of V2X systems.

The proliferation of V2X services offered by various providers introduces a complex ecosystem of potential vulnerabilities. This diversity creates challenges in standardizing security practices across different implementations and in providing for seamless compatibility. Additionally, the limitations of existing solutions become more pronounced as the scale of V2X deployment expands. These limitations include the risk of exposing sensitive information during communication. As V2X systems exchange data that may include personal identifiers, passwords, or biometric data, there's a heightened risk of unauthorized access or interception, potentially leading to identity theft, fraud, or compromised privacy. Moreover, integrating robust security measures into V2X systems introduces an increase in computational overhead that can potentially strain the resources of resource-constrained vehicular devices and infrastructure devices. This additional computational load has the potential to impact real-time responsiveness and overall system performance, necessitating careful optimization of security protocols to strike a balance between security and system efficiency.

Therefore, there is a need for systems and methods of cross-domain authentication in edge-enabled vehicle-to-everything (V2X) services that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

Apparatus, methods and systems for cross-domain authentication in edge-enabled vehicle-to-everything (V2X) services may be provided according to one or more aspects. According to an aspect, a method for generating identity credential may be provided. The method may include receiving, by an identity server (IS) from a user (or a vehicle user), a request for an identity credential, C_{id}. The request may include one or more of: an identifier (ID) of the user, a commitment parameter C generated based on two random values r and v, a parameter T generated based on two random values a and t, and a proof transcript indicating ownership of r and v. The method may further include generating, by the IS, a signature σ′ based on the commitment parameter C and a random value u. The method may further include sending, by the IS to the user, the generated signature σ′ usable by the user to obtain the identity credential C_{id}.

The method may further include, parsing, by the IS, the request to obtain the commitment parameter C. The method may further include verifying, by the IS, the ownership of the two random values r and v.

The method may further include generating, by the IS, system parameters [symbol] which may be given by {p, [symbol] , H, H₁}. Here, [symbol] and [symbol] may be three cyclic multiplicative groups of a prime order p, where 2^{λ}≤p≤2^{λ+1}, and e may be a bilinear map e: [symbol] . Further, Γ={p, [symbol] , e} may be generated via a type-3 pairing-group generator G and 1^{λ}. λ may be a security parameter that represents a level of security for a cryptographic scheme. [symbol] and [symbol] may be denoted as [symbol] and [symbol] . H and H₁ may be hash functions and, respectively, based on: H:{0,1}*→ [symbol] and H₁: [symbol] .

The method may further include generating, by the IS, a private key X and a public key (g, Y, \tilde{g}, \tilde{X}, \tilde{Y}). The public key may be generated according to:

$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$

and (X, Y)=(g^{x}, g^{y}) and (\tilde{X}, \tilde{Y})=(\tilde{g}^{x}, \tilde{g}^{y}), where (here and elsewhere) $ means that a value is randomly chosen from a group.

The commitment parameter C may be generated according to C=g^{r}Y^{v}. The parameter v may be a private key of the user and is generated according to

$$v {←}^{\$} {ℤ}_{p} .$$

The parameter r may be used to randomize the commitment parameter C and is generated according to

$$r {←}^{\$} {ℤ}_{p} .$$

Parameter u may be generated according to:

$$u {←}^{\$} {ℤ}_{p}$$

and the parameter T may be generated according to: T=at, where t and a are generated, respectively, according to:

$$t {←}^{\$} {ℤ}_{p} and a {←}^{\$} {ℤ}_{p} .$$

The proof transcript may be based on a non-interactive zero-knowledge proof. The proof transcript may include one or more of: (T_{C}, r′, v′). The parameter T_{C}=g^{ρ}^{ᵣ}Y^{ρ}^{ᵥ}, where ρᵣ, ρᵥ are randomly generated according to:

$${ρ}_{r} , {ρ}_{v} {←}^{\$} {ℤ}_{p} .$$

The parameter r′=ρᵣ−cr. The parameter v′=ρᵥ−cv. The parameter c=H₁(T_{C}).

According to an aspect, a method of generating a credential with an anonymous characteristic may be provided. The method may include receiving, by a service provider (SP) from a user, a request to subscribe to a service. The request may include one or more of: an identifier (ID) of the user, a parameter \tilde{Y}^{v}, an identity credential, σ, of the user, a random variable a, and an indication of the service sᵢ. The parameter \tilde{Y}, in parameter \tilde{Y}^{v}, may be a component of a public key of an identity server (IS). The parameter v, in parameter \tilde{Y}^{v}, may be a random variable generated according to

$$v {←}^{\$} {ℤ}_{p} .$$

The random variable a may be generated according to

$$a {←}^{\$} {ℤ}_{p} .$$

The method may further include generating, by the SP, a service credential, Cₛ_{ᵢ}, based on the identity credential σ of the user and the indication of the service sᵢ.

The method may further include parsing, by the SP, the request to obtain the identity credential, σ, of the user. The method may further include verifying, by the SP, the identity credential, σ, of the user.

The identity credential, σ, may be verified according to: e(σ₁, \tilde{X}\tilde{Y}^{v})=e(σ₂, \tilde{g}), where σ₁ and σ₂ are components of the identity credential σ. The parameter e is a bilinear map determined according to: e: [symbol] may be three cyclic multiplicative groups of a prime order p, where 2^{λ}≤p≤2^{λ+1}. Parameters \tilde{g} and \tilde{X} may be components of a public key, (g, Y, \tilde{g}, \tilde{X}, \tilde{Y}), of the IS, where

$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$

and (X, Y)=(g^{x}, g^{y}) and (\tilde{X}, \tilde{Y})=(\tilde{g}^{x}, \tilde{g}^{y}).

The service credential Cₛ_{ᵢ} may be a signature σᵢ generated according to: (σ_{i,1}, σ_{i,2})=(σ₁^{t}^{ᵢ},(σ₂σ₁^{y}^{ᵢ}^{H(s}^{ᵢ}⁾)^{t}^{ᵢ})=(g^{ut}^{ᵢ}, g^{ut}^{ᵢ}^{(x+yv+y}^{ᵢ}^{H(s}^{ᵢ}⁾⁾). The parameters σ_{i,1}, σ_{i,2} may be components of the signature σᵢ. The parameter yᵢ may be a private key of the SP and is randomly generated according to

$${y}_{i} {←}^{\$} {ℤ}_{p} .$$

The parameter tᵢ may be a random variable generated according to

$${t}_{i} {←}^{\$} {ℤ}_{p} .$$

The parameter H may be a hash function and is based on: H:{0,1}*→ [symbol] . The parameters u and v may be random variables generated, respectively, according to

$$u {←}^{\$} {ℤ}_{p} and v {←}^{\$} {ℤ}_{p} .$$

The method may further include generating, by the SP, a proof transcript using a non-interactive zero-knowledge (NIZK) proof to prove validity of the signature σᵢ. The method may further include sending, by the SP to an identity server (IS), the proof transcript.

The proof transcript may include

$$( {T}_{{σ}_{i}} , {s}_{i}^{′} ) .$$

The NIZK proof may be based on NIZK{(sᵢ):e(σ_{i,1}, \tilde{X}\tilde{Y}^{v}\tilde{Y}ᵢ^{H(s}^{ᵢ}⁾)=e(σ_{i,2}, \tilde{g})}. Generating the proof transcript may include computing:

$${T}_{{σ}_{i}} = e {( {σ}_{i , 2} , {\tilde{Y}}_{i} )}^{{ρ}_{{s}_{i}}} ,$$

where ρₛ_{ᵢ} is a random variable generated according to

$${ρ}_{{s}_{i}} {←}^{\$} {ℤ}_{p} ,$$

and \tilde{Y}ᵢ is a public key of the SP providing the service indicated by sᵢ. The parameter \tilde{Y}ᵢ may be generated according to: \tilde{Y}ᵢ=\tilde{g}^{y}^{ᵢ}. Generating the proof transcript may further include computing c=H₁(T_{σ}_{ᵢ}), where H₁ is another hash function and is based on H₁: [symbol] . Generating the proof transcript may further include computing

$${s}_{i}^{′} = {ρ}_{{s}_{i}} - c H ( {s}_{i} ) .$$

The NIZK proof may be performed while preserving the privacy of service sᵢ. The method may further include sending, by the SP to the IS, the ID of the user, the signature σᵢ and parameter Tᵢ. The parameter Tᵢ may be determined according to Tᵢ=atᵢ, where a is a random value generated according to:

$$a {←}^{\$} {ℤ}_{p} .$$

According to another aspect, a method for generating a credential with an anonymous characteristic may be provided. The method may include receiving, by an identity server (IS), a request message indicative of a request to generate an anonymous credential for a user. The request message may include an identifier (ID) of a user. The request message may further include a signature, σᵢ, generated based on an identity credential, σ, of the user and is related to a service indicated via sᵢ. The request message may further include a parameter Tᵢ, where Tᵢ=atᵢ, where a and tᵢ are random values generated respectively according to:

$${t}_{i} {←}^{\$} {ℤ}_{p} , and a {←}^{\$} {ℤ}_{p} .$$

The method may further include verifying, by the IS, validity of the signature σᵢ. The method may further include generating, by the IS, an anonymous credential σ_{S} for the user based on the signature σᵢ.

The method may further include generating, by the IS, system parameters [symbol] which may be given by {p, [symbol] , H, H₁}. [symbol] may be three cyclic multiplicative groups of a prime order p, where 2^{λ}≤p≤2^{λ+1}, and e may be a bilinear map e: [symbol] . Here, Γ={p, [symbol] , e} may be generated via a type-3 pairing-group generator G and 1^{λ}. λ may be a security parameter that represents a level of security for a cryptographic scheme. [symbol] and [symbol] may be denoted as [symbol] and [symbol] . H and H₁ may be hash functions, respectively, based on: H:{0,1}*→ [symbol] and H₁: [symbol] . The method may further include generating, by the IS, a private key X and a public key (g, Y, \tilde{g}, \tilde{X}, \tilde{Y}), where

$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$

and (X, Y)=(g^{x}, g^{y}) and (\tilde{X}, \tilde{Y})=(\tilde{g}^{x}, \tilde{g}^{y}).

Verifying, by the IS, validity of the signature σᵢ may include testing if

$$c = {H}_{1} ( e {( {σ}_{i , 1} , \tilde{Y} )}^{v ′} {( \frac{e ( {σ}_{i , 2} , \tilde{g} )}{e ( {σ}_{i , 1} , \tilde{X} {\tilde{Y}}^{{}_{ν}} )} )}^{c} ) .$$

Here, σ_{i,1}, σ_{i,2} may be components of the signature σᵢ. The parameter v′ may be a component of a proof transcript of the user, where v′=ρᵥ−cv. The parameter c may be determined according to c=H₁(T_{C}). The parameter T_{c} may be determined according to T_{C}=g^{ρ}^{ᵣ}Y^{ρ}^{ᵥ}, where ρᵣ, ρᵥ may be randomly generated according to:

$${ρ}_{r} , {ρ}_{v} {←}^{\$} {ℤ}_{p} .$$

The parameter v may be a private key of the user and a value randomly generated according

$$v {←}^{\$} {ℤ}_{p} .$$

The method may further include generating, by the IS, a parameter σᵢ′ based on the signature σᵢ according to: σᵢ′=(σ_{i,1}′, σ_{i,2}′)=(σ_{i,1}^{T/T}^{ᵢ}, σ_{i,2}^{T/T}^{ᵢ})=(g^{ut}, g^{ut(x+yv+y}^{ᵢ}^{H(s}^{ᵢ}⁾⁾). The method may further include storing, by the IS, the anonymous credential σ_{S} for service authentication. The parameter T may be determined according to T=at, where t is a random value generated according to

$$t {←}^{\$} {ℤ}_{p} .$$

The parameter u may be a random variable generated according to

$$u {←}^{\$} {ℤ}_{p} .$$

The parameter yᵢ may be a private key of a service provider (SP) of the service and randomly generated according to

$${y}_{i} {←}^{\$} {ℤ}_{p} .$$

Generating, by the IS, the anonymous credential σ_{S} may include: aggregating, by the IS, {σᵢ′}, i∈S, where S is a set of indices of services to which the user is subscribed, to generate the anonymous credential σ_{S} with a constant size, according to σ_{S}=(σ_{S,1}, σ_{S,2})=(σ_{i,1}′, Π_{i,i∈S}σ_{i,2}′)=(g^{ut}, g^{utΣ}^{_{i,i∈S}}^{(x+yv+y}^{ᵢ}^{H(s}^{ᵢ}⁾⁾).

According to an aspect, a method of identity and service authentication may be provided. The method may include receiving, by an edge server (ES) from a user, a request for a service and a proof transcript. The request may include a randomized identity credential, \tilde{σ}, of the user based on an identity credential, σ, of the user. The request may further include an indication of the service, sⱼ. The request may further include a parameter, \tilde{g}^{f}, for service verification. The parameter \tilde{g}^{f} may be based on a public key of an identity server (IS) and a random value f generated according to

$$f {←}^{\$} {ℤ}_{p} .$$

The request may further include a parameter \tilde{Y}ⱼ^{f} generated based on: a public key, \tilde{Y}ⱼ (of a service provider (SP) providing the service) and the random value f. The request may further include a parameter A generated based on the public key of the IS. The request may further include a parameter [symbol] which is a ciphertext of an identifier (ID) of the user. The method may further include parsing, by the ES, the request to obtain the randomized identity credential, \tilde{σ}, of the user. The method may further include verifying, by the ES, the validity of the randomized identity credential, \tilde{σ}, of the user. The method may further include sending, by the ES to an identity server (IS), a service authentication request message to verify whether the user has been authorized to access the service. The method may further include receiving, by the ES from the IS, a service authentication response message indicating whether the user is authorized to access the service.

The public key of the IS may include one or more of: (g, Y, \tilde{g}, \tilde{X}, \tilde{Y}), where

$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$

and (X, Y)=(g^{x}, g^{y}) and (\tilde{X}, \tilde{Y})=(\tilde{g}^{x}, \tilde{g}^{y}). [symbol] and [symbol] may be denoted as [symbol] and [symbol] . Further, [symbol] may be based on a bilinear map e: [symbol] , where [symbol] are a set of three cyclic multiplicative groups of a prime order p, where 2^{λ}≤p≤2^{λ+1}, and λ is a security parameter that represents a level of security for a cryptographic scheme.

The parameter A may be generated according to:

$$A = {( \tilde{X} {\tilde{Y}}^{{}_{v}} {\prod }_{i ∈ S , i \neq j} \tilde{X} {\tilde{Y}}^{{}_{v}} {\tilde{Y}}_{i}^{H ( {s}_{i} )} )}^{f} ,$$

where v is a value randomly generated according to

$$v {←}^{\$} {ℤ}_{p}$$

and S is a set of indices of services to which the user is subscribed. The parameter \tilde{Y}ᵢ may be a public key of a service provider providing another service indicated by sᵢ, and H may be a hash function of the IS and is based on: H:{0,1}*→ [symbol] .

The service authentication request message may include a parameter A′ where

$${A}^{′} = A \cdot {\tilde{Y}}_{j}^{f \cdot H ( {s}_{j} )} = {( {\prod }_{i ∈ S} \tilde{X} {\tilde{Y}}^{{}_{v}} {\tilde{Y}}_{i}^{H ( {s}_{i} )} )}^{f} .$$

The service authentication request message may further include a signed parameter signₛₖ_{_{ε}}(A′) based on the parameter A′. The service authentication request message may further include the parameter \tilde{g}^{f} and the parameter [symbol] .

The randomized identity credential, \tilde{σ}, may be generated according to: \tilde{σ}=(σ₁^{b},(σ₂σ₁^{d})^{b})=(g^{ub}, g^{ub(x+yv+d)}), where σ₁ and σ₂ are components of the identity credential σ. The parameters b and d may be random values generated according to b,

$$d {←}^{\$} {ℤ}_{p}^{2} .$$

Further, the parameter u may be a random variable generated according to:

$$u {←}^{\$} {ℤ}_{p} .$$

The proof transcript may indicate the user's ownership of variables v and d. The proof transcript may include one or more of: (T_{\tilde{σ}}, v′, d′). The proof transcript may be based on a non-interactive zero-knowledge (NIZK) proof according to: NIZK{(v, d):e(\tilde{σ}₁, \tilde{X}\tilde{Y}^{v}g^{f})=e(\tilde{σ}₂, \tilde{g})}. The parameters \tilde{σ}₁ and \tilde{σ}₂ may be components of the randomized identity credential, \tilde{σ}. The parameter T_{\tilde{σ}} in the proof transcript may be generated according to T_{\tilde{σ}}=e(\tilde{σ}₁, \tilde{Y})^{ρ}^{ᵥ}e(\tilde{σ}₁, g)^{ρ}^{_{d}}, where ρᵥ and ρ_{d} are random values generated according to

$${ρ}_{v} , {ρ}_{d} {←}^{\$} {ℤ}_{p} .$$

The parameter v′ may be generated according to v′=ρᵥ−cv where c=H₁(T_{\tilde{σ}}), and H₁ is another hash function of the IS and is based on H₁: [symbol] . The parameter d′ may be generated according to d′=ρ_{d}−cd.

Verifying, by the ES, the validity of the randomized identity credential, \tilde{σ}, of the user may include testing if

$$c = {H}_{1} ( e {( {\tilde{σ}}_{1} , \tilde{Y} )}^{v ′} e {( {\tilde{σ}}_{1} , \tilde{g} )}^{{d}^{{}_{′}}} {( \frac{e ( {\tilde{σ}}_{2} , \tilde{g} )}{e ( {\tilde{σ}}_{1} , \tilde{X} )} )}^{c} ) .$$

According to another aspect, a method for identity and service authentication may be provided. The method may include receiving, by an identity server (IS) from an edge server (ES), a service authentication request message to verify whether a user has been authorized to access a service. The method may further include retrieving, by the IS, an anonymous credential σ_{S} of the user indicating one or more services to which the user has subscribed. The method may further include generating, by the IS, a result indicating whether the user is authorized to access the service based on the retrieved anonymous credential σ_{S}.

The method may further include generating, by the IS, system parameters [symbol] given as {p, [symbol] , H, H₁}. Where [symbol] and [symbol] may be a set of three cyclic multiplicative groups of a prime order p, where 2^{λ}≤p≤2^{λ+1}, along with a bilinear map e: [symbol] . Further, Γ={p, [symbol] , e} may be generated via a type-3 pairing-group generator G and 1^{λ}. λ may be a security parameter that represents a level of security for a cryptographic scheme. [symbol] and [symbol] may be denoted as [symbol] and [symbol] H and H₁ may be hash functions and, respectively, based on: H:{0,1}*→ [symbol] and H₁:

[symbol]

The method may further include generating, by the IS, a private key X and a public key (g, Y, \tilde{g}, \tilde{X}, \tilde{Y}). Here, the public key is generated according to:

$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$

and (X, Y)=(g^{x}, g^{y}) and (\tilde{X}, \tilde{Y})=(\tilde{g}^{x}, \tilde{g}^{y}).

The service authentication request message may include a parameter A′ where

$${A}^{′} = A \cdot {\tilde{Y}}_{j}^{f \cdot H ( {s}_{j} )} = {( {\prod }_{i ∈ S} \tilde{X} {\tilde{Y}}^{{}_{v}} {\tilde{Y}}_{i}^{H ( {s}_{i} )} )}^{f} .$$

The service authentication request message may further include an indication of a sign of the parameter A′ as signₛₖ_{_{ε}}(A′). The service authentication request message may further include a parameter \tilde{g}^{f} generated based on: a public key of the identity server (IS) and the value f. The service authentication request message may further include a parameter [symbol] , which is a ciphertext of an identifier (ID) of the user. The parameter A may be generated according to

$$A = {( \tilde{X} {\tilde{Y}}^{{}_{v}} {\prod }_{i ∈ S , i \neq j} \tilde{X} {\tilde{Y}}^{{}_{v}} {\tilde{Y}}_{i}^{H ( {s}_{i} )} )}^{f} ,$$

where S is a set of indices of one or more services to which the user is subscribed. Parameters v and f may be random values generated, respectively, according to

$$v {←}^{\$} {ℤ}_{p} and f {←}^{\$} {ℤ}_{p} .$$

Parameter \tilde{Y}ᵢ may be a public key of a service provider (SP) providing another service indicated by sᵢ. Parameter \tilde{Y}ⱼ may be a public key of an SP providing the service indicated by sⱼ.

The method may further include verifying, by the IS, the signed parameter signₛₖ_{_{ε}}(A′). The method may further include decrypting, by the IS, the parameter [symbol] to obtain an ID of the user, wherein the anonymous credential σ_{S} of the user is retrieved based on the obtained ID of the user.

Generating, by the IS, the result indicating whether the user is authorized to access the service based on the retrieved anonymous credential σ_{S} may include checking, by the IS, whether e(σ_{S,1}, A′)=e(σ_{S,2}, \tilde{g}^{f}), where σ_{S,1} and σ_{S,2} are components of the retrieved anonymous credential σ_{S}.

The method may further include sending, by the IS to the ES, a service authentication response indicating whether the user is authorized to access the service based on the result. The method may further include randomizing, by the IS, the retrieved anonymous credential σ_{S} to obtain a randomized anonymous credential \tilde{σ}_{S} according to \tilde{σ}_{S}=(\tilde{σ}_{S,1}, \tilde{σ}_{S,2})=(σ_{S,1}^{k}, σ_{S,2}σ_{S}_{₁}^{l})^{k}, where k and l are random values generated according to: k,

$$l {←}^{\$} {ℤ}_{p}^{2} .$$

The method may further include integrating, by the IS, into a transaction of a public blockchain authentication result data comprising: {\tilde{σ}_{S}, A′, signₛₖ_{_{ε}}(A′), \tilde{g}^{f}, \tilde{g}^{fl}}.

According to an aspect, a method for auditing authentication results of an identity server may be provided. The method may include receiving, by one or more nodes of a public blockchain from an identity server (IS), via a transaction on the public blockchain, authentication result data indicating a result of a service authentication request to verify whether a user has been authorized to access a service. The authentication result data includes a signature of an edge server (ES). The method may further include verifying, by the one or more nodes of the public blockchain, based on a randomized anonymous credential of the user, the signature of the ES to check that the service authentication request is from a service-deployed ES that provides the service.

The signature of the ES may be a signature of A′, signₛₖ_{_{ε}}(A′), where A′ is a parameter associated with the ES, the authentication result data may further include one or more of: {\tilde{σ}_{S}, A′, \tilde{g}^{f}, \tilde{g}^{fl}}. The parameter \tilde{σ}_{S} may be the randomized anonymous credential of the user based on an anonymous credential of the user that indicates one or more services to which the user is subscribed. The parameter A′ may be determined according to

$${A}^{′} = A \cdot {\tilde{Y}}_{j}^{f \cdot H ( {s}_{j} )} = {( {\prod }_{i ∈ S} \tilde{X} {\tilde{Y}}^{{}_{v}} {\tilde{Y}}_{i}^{H ( {s}_{i} )} )}^{f} .$$

where

$$A = {( \tilde{X} {\tilde{Y}}^{{}_{v}} {\prod }_{i ∈ S , i \neq j} \tilde{X} {\tilde{Y}}^{{}_{v}} {\tilde{Y}}_{i}^{H ( {s}_{i} )} )}^{f} ,$$

where S is a set of indices of one or more services to which the user is subscribed. The parameters v, f and l may be random values generated according to: v, f,

$$l {←}^{\$} {ℤ}_{p}^{3} .$$

The parameter \tilde{Y}ᵢ may be a public key of a service provider (SP) providing another service indicated by sᵢ. The parameter \tilde{Y}ⱼ is a public key of an SP providing the service indicated by sⱼ. The parameters \tilde{g}, \tilde{X}, and \tilde{Y} may be components of a public key of the IS. The parameter H may be a hash function of the IS and is based on: H:{0,1}*→ [symbol] .

The method may further include verifying, by the one or more nodes of the public blockchain, the randomized anonymous credential \tilde{σ}_{S} by checking whether e(\tilde{σ}_{S,1}, A′)·e(\tilde{σ}_{S,1}, \tilde{g}^{fl})=e(\tilde{σ}_{S,2}, \tilde{g}^{f}) to obtain a verification result. Verifying, by the one or more nodes of the public blockchain, the signature of the ES may include verifying the signature of A′ to guarantee that A′ comes from the service authentication request of the service-deployed ES. The parameter e may be determined according to e: [symbol] . The parameters [symbol] may be a set of three cyclic multiplicative groups of a prime order p, where 2^{λ}≤p≤2^{λ+1} and λ is a security parameter that represents a level of security.

The method may further include comparing, by the one or more nodes of the public blockchain, the verification result with the authentication result data to determine whether the IS can be trusted.

According to another aspect, an apparatus is provided. The apparatus includes modules configured to perform one or more of the methods and systems described herein. The apparatus may be implemented using electronics, such as but not necessarily limited to one or more computer processors executing computer program instructions stored in memory, or comparable electronics configured to perform operations as described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a system architecture, according to an embodiment.

FIG. 2 illustrates a method initializing a system for cross-domain authentication, according to an aspect.

FIG. 3 illustrates a method for identity registration, according to an embodiment.

FIG. 4 illustrates a method for subscribing to one or more services, according to an embodiment.

FIG. 5 illustrates a method for identity and service authentication, according to an embodiment.

FIG. 6 illustrates a method for auditing authentication results of an identity server, according to an embodiment.

FIG. 7 illustrates an apparatus that may perform any or all of operations of the above methods and features explicitly or implicitly described herein, according to different aspects of the present disclosure.

It will be noted that throughout the appended drawings, like features are identified by like reference numerals.

### DETAILED DESCRIPTION

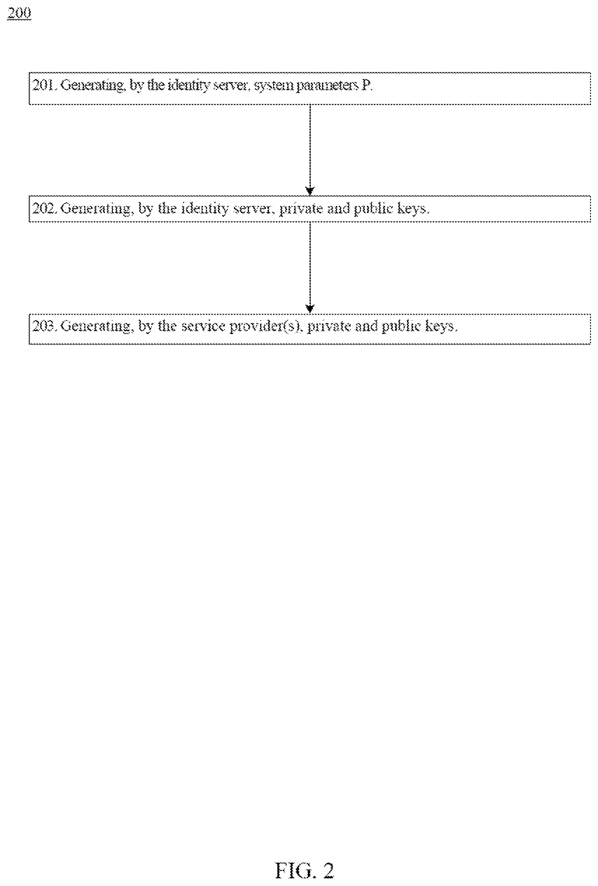

Apparatus, methods and systems for cross-domain authentication in edge-enabled vehicle-to-everything (V2X) services may be provided according to one or more aspects. According to an aspect, and with reference to FIG. 2, a method 200 for initializing a system for cross-domain authentication may be provided. The method includes generating 201, by an identity server (IS) 140, system parameters. The method may further include generating 202, by the identity server, private and public keys. The method may further include generating 203, by one or more service providers, private and public keys.

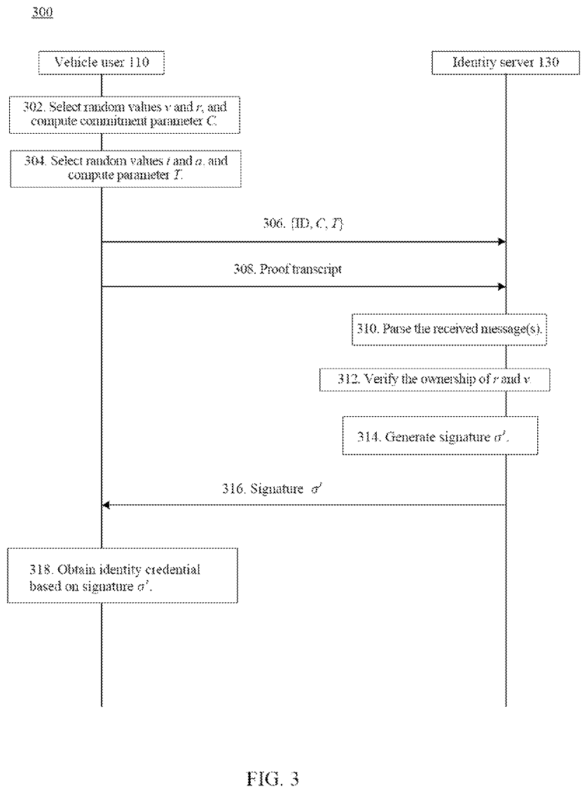

According to another aspect, and with reference to FIG. 3, a method 300 for identity registration of a vehicle user (or user) may be provided. The method includes sending by a vehicle user 110 (which may refer to a device owned by the vehicle user, the device being a vehicle, a user equipment or other computing device) to an identity server 130, a request message 306 {ID, C, T} and 308 requesting to generate an identity credential for the vehicle user. The request message may include one or more parameters needed by the identity server to generate the identity credential. The identity server may perform parsing 310 and verification 312 operations on the received request message to further generate 314 a signature σ′. The identity server may send the generated signature σ′ 316 to the vehicle user, which can obtain 318 the identity credential from the signature σ′. A user (or vehicle user) may refer to an electronic device, for example installed in a vehicle, and which is communicatively coupled to other devices as described herein. The identity information associated with the user (also referred to as a user device) may, in some embodiments, be identity information which is inherited from a human user, organization, or other identifiable entity.

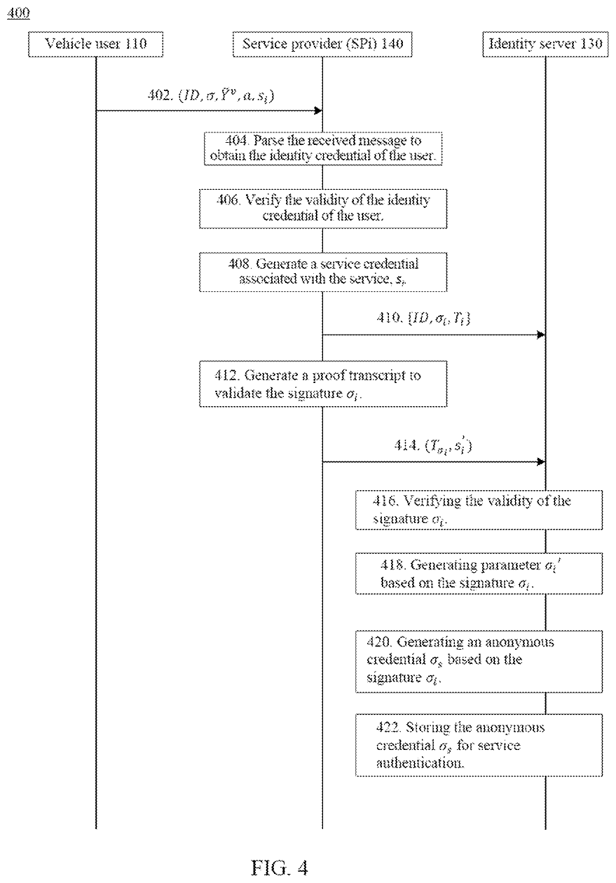

According to another aspect, and with reference to FIG. 4, a method 400 for subscribing to one or more services may be provided. The method may include a vehicle user 110 sending a request message 402 to a service provider 140 for subscribing to a service. The service provider may perform parsing 404 and verification 406 operations to generate 408 a service credential associated with the requested service. The service provider may then send a request message 410 to the identity server 130 to generate an anonymous credential for the vehicle user. The identity server may then verify 416 the request message 410 of the service provider and generate 420 the anonymous credential.

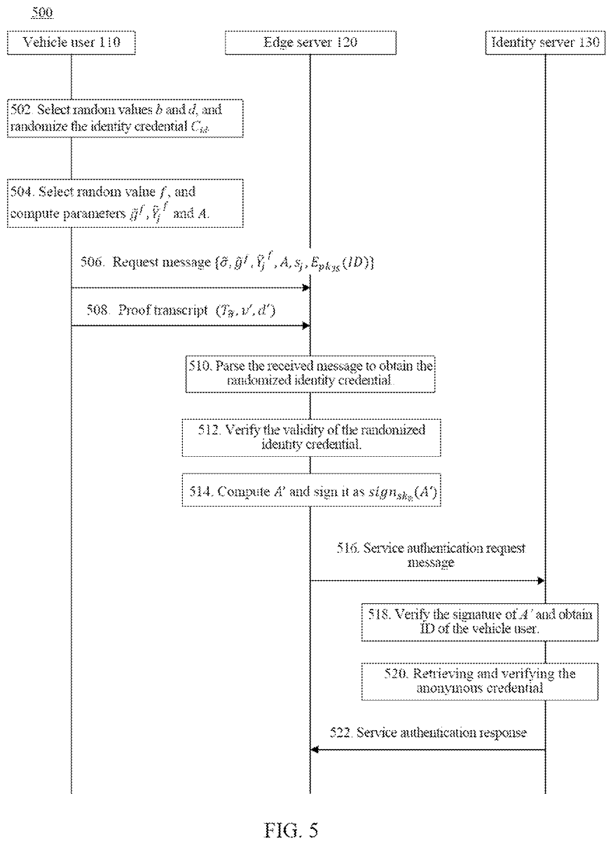

According to another aspect, and with reference to FIG. 5, a method 500 for identity and service authentication may be provided. The method includes a vehicle user 110 sending a request message 506 to an edge server request for a service. The request message may include parameters for the edge server 120 to verify the request. The edge server may parse 510 the received message to obtain and verify 512 the randomized identity credential of the vehicle user. The edge server may further send a service authentication request message 516 to an identity server 130 to authenticate the request for service of the vehicle user. The request message 516 may include a signature of the edge server. The identity server may verify 518 the signature of the edge server and obtain an ID of the vehicle user. The identity server may further retrieve and verify 520 an anonymous credential of the vehicle user. Accordingly, the identity server may determine an authentication result based on the verification of the anonymous credential.

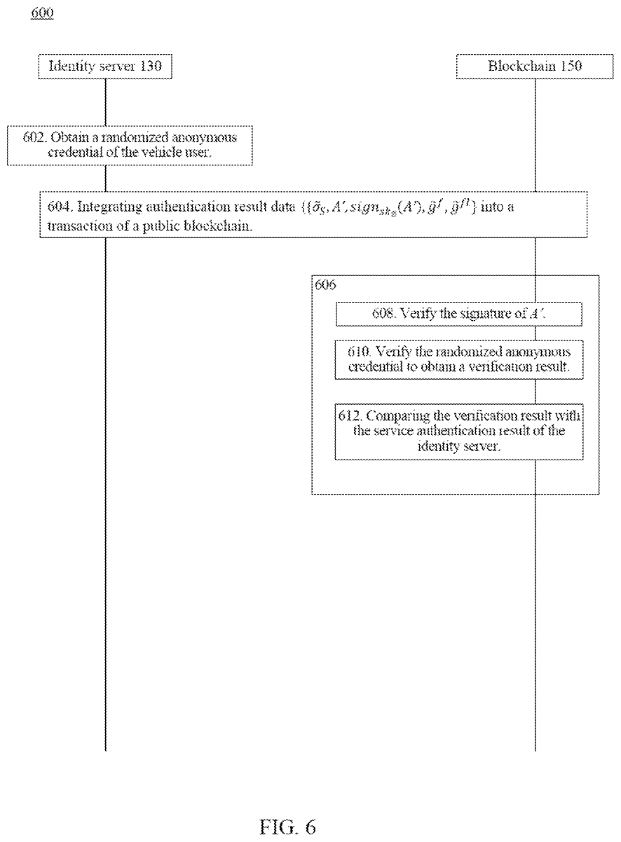

According to an aspect, and with reference to FIG. 6, a method 600 for auditing authentication results of an identity server may be provided. The method includes integrating 604 (e.g., publishing), by an identity server 130 via a blockchain 150, authentication result data (e.g., based on the method 500) of an authentication procedure related to a vehicle user into a transaction of a public blockchain. In doing so, the identity server may further randomize an anonymous credential of the vehicle user. One or more blockchain nodes of the public blockchain may obtain an authentication result and further compare the blockchain-obtained authentication result with the authentication result data received from the identity server to determine whether the identity server is trustworthy.

Vehicle-to-Everything (V2X) is a technology that provides for communication and interaction between vehicles and their environment. V2X encompasses a diverse array of communication protocols and systems, potentially facilitating the exchange of information between vehicles, infrastructure, pedestrians, and even networks and cloud-based services. The benefits of V2X may be far-reaching and impactful. V2X may enhance road safety by providing real-time updates on nearby vehicles, road conditions, and potential hazards. This empowers drivers to make proactive decisions and facilitates advanced driver assistance systems, ultimately leading to a reduction in accidents. Moreover, V2X may improve traffic efficiency by optimizing the flow of vehicles, reducing congestion, and facilitating cooperative maneuvers between cars. Additionally, V2X may play an important role in enabling intelligent transportation systems, supporting features such as automated driving, smart parking, and adaptive traffic management. With its wide-ranging applications, V2X may hold significant potential to transform transportation experiences, potentially leading to safer and more efficient roads for all. Currently, some V2X services have been embedded into advanced driver assistance systems (ADAS) that assist drivers in driving and parking functions, and others are independent applications that drivers can subscribe to from different service providers. For example, Google™ has Gmail™, YouTube™, Google+™, etc., which can be accessed by the drivers and passengers from the vehicle application programming interfaces (APIs).

Security in V2X is of significant importance due to the critical nature of the information exchanged and the potential risks involved. With the increasing adoption of V2X technology, ensuring robust security measures becomes crucial to safeguard against potential threats. According to some statistics from Statista™, by 2025, around 400 million connected cars are estimated to be on the roads globally. With such a vast number of vehicles relying on V2X communication, the potential threats become more pronounced. According to a report by Frost & Sullivan™, the global automotive cybersecurity market is projected to reach $2.7 billion by 2025, indicating growing concerns and investments in securing connected vehicles and V2X systems. Furthermore, according to a report from ISRAEL21c™, the frequency of cyberattacks on cars increased 225% from 2018 to 2021. These attacks can have far-reaching implications, ranging from unauthorized access to critical vehicle functions, such as braking or steering, to data breaches compromising personal information. Therefore, there is a need for robust security guarantees in V2X to protect against cyber threats and ensure the safety and privacy of drivers and passengers.

Authentication plays a pivotal role in ensuring the security and reliability of V2X communication. In the dynamic V2X ecosystem, where vehicles, infrastructure, and various entities interact, authentication serves as a critical mechanism for verifying the identities of and the messages from participating entities and establishing secure connections. Authentication may involve checking a vehicle user's identity to see whether the vehicle user is authorized to access the services. The importance of it is notably significant, as it acts as a powerful deterrent against unauthorized access, data manipulation, and malicious activities. By employing robust authentication protocols, V2X service providers can effectively validate the legitimacy of vehicles, infrastructure components, and other entities, thereby mitigating the risks of impersonation and unauthorized interference. This authentication process may foster a foundation of trust among vehicles, enabling secure information exchange, cooperative maneuvers, and reliable decision-making in the V2X environment. Through the implementation of effective authentication mechanisms, V2X systems can ensure the integrity, privacy, and safety of the connected ecosystem, ultimately enhancing road safety and improving the overall efficiency of transportation systems.

However, due to the increasing number of V2X services offered by different service providers, conventional authentication, such as password-based authentication, becomes costly or impractical. For example, drivers cannot input username or password for authentication during driving. Although the vehicles have the capability to maintain the passwords of various services for a driver, there is a high risk of the stored pairs being disclosed. Moreover, popular authentication mechanisms, such as password-based authentication or authentication in Global System for Mobile communication (GSM) system, expose a user's identity to the service provider or potential adversaries, which may result in privacy leakage. Identity privacy preservation in V2X services may be essential, as the identity of a driver can be directly linked to the driver's trajectory and points of interest. In addition, through the access frequency of specific services, it is easy to predict the preferences of the driver. This information, including identity, location, interests, or preferences are personal data that are required to be protected according to privacy act, such as Europe General Data Protection Regulation (GDPR) and Canada Personal Information Protection and Electronic Documents Act (PIPEDA). To preserve privacy, anonymous authentication may be required, which preserves users' identities against service providers, so that the trajectory and location information cannot be directly linked to a specific user. According to some aspects, an anonymous credential for a service provider may be provided that can deal with the various V2X on-board services.

Moreover, with the increasing capability of data storage and computation, roadside infrastructure and devices are capable of supporting data caching and local V2X services on behalf of edge servers. With enhanced edge capability, vehicles can access the needed data and services from the edge servers, instead of acquiring them from the remote servers controlled by the service provider. Therefore, authentication between the vehicles and the edge servers may be necessary to secure V2X services. However, the connection between users and edge servers may be short-lived, due to the high mobility of the vehicles. Further, interacting with the remote servers in each authentication may be overwhelming. Even worse, the servers of the service providers may be “off-line”, but conventional authentication depends on an “always-online” authentication server. Therefore, authentication between the users and the edge servers who are allocated by the centralized service providers to provide V2X services may be desired and advantageous. According to some aspects, the user may be authenticated by the edge server who offers the service that the user requests to access. The authentication may be based on anonymous authentication as described herein.

Additionally, with the increasing number of V2X service providers that offer various services to drivers and passengers, improving the efficiency of user (vehicle user) authentication may be desirable and important. Although cross-domain authentication potentially reduces the overhead of vehicle users, service providers, and edge servers during authentication, such authentication is built upon the assumption that the service provider and the edge server fully trust a fixed identity server that creates anonymous credentials and manages user authentication and service authentication for them. A typical example of cross-domain authentication is Single Sign-On (SSO), which facilitates users to use a set of credentials offered by another service provider, such as Google™, Apple™, and Meta™, to access multiple applications or services. This SSO needs unconditional trust between the service providers and the identity server of SSO. The service provider and the edge server may entirely rely on the returned authentication results from another service provider to determine if the service can be offered. Such unconditional trust can be dangerous. If the identity server is compromised, misbehavior might not be identifiable and may cause serious consequences. Therefore, according to some aspects, a trust between service providers and an SSO identity server may be established to trace and minimize the risk of potential malicious behaviors of the identity server.

Existing solutions of authentication can be classified in several categories. Password-based authentication is a widely used method of authentication in network and information systems. Password-based authentication involves users providing a unique password that matches a pre-registered password associated with their account. The password is typically a combination of alphanumeric characters and can be further strengthened with requirements for minimum length, complexity, and periodic changes. Although password-based solutions are simple and easy to use, they are vulnerable to off-line guessing attacks. One way to address this weakness is that the systems enforce password policies that encourage users to choose strong passwords or regularly prompt users to update their passwords. Another way to deal with off-line guessing attacks is to combine the passwords with additional factors, such as short message/messaging service (SMS) codes, biometrics, or hardware tokens, to implement multi-factor authentication. This adds an extra layer of protection, as both something the user knows (e.g., password) and something the user has or is (second factor) are required for authentication.

Another category of authentication solutions is certificate-based authentication. This category relies on the use of a digital certificate to verify the identity of a user or entity accessing the system. A certificate is issued by a trusted certificate authority (CA) and contains a public key and other identifying information, all digitally signed by the CA. Certificate-based authentication provides a high level of security since the private key used to sign the certificate remains securely stored on the user's device, reducing the risk of unauthorized access. Currently, certificate-based authentication has been standardized, but concerns on the heavy cost of certificate management, including issuance, revocation, and validation, have been raised. To address this issue, various alternatives have been proposed, including identity-based authentication, certificateless authentication, and blockchain-based certificate management. Identity-based authentication and certificateless authentication eliminate the need for certificates on user identity verification by utilizing real identities, such as email addresses and phone numbers. Blockchain-based certificate management utilizes the blockchain technology to enhance the security, transparency, and efficiency of digital certificate management by eliminating the reliance on a single centralized authority and reducing the risk of certificate fraud or tampering.

Biometric authentication is another category of authentication solutions which offers a more secure and convenient alternative to conventional authentication methods like passwords. It utilizes distinct unique biological or behavioral characteristics to authenticate users and grant them access to systems, devices, or services. These characteristics, known as biometric traits, can include fingerprints, facial features, iris or retinal patterns, voiceprints, palmprints, or even behavioral patterns like typing style or gait recognition. Biometric authentication has been widely used for access control, where biometric traits such as fingerprints or facial recognition are employed to grant authorized individuals access to secure premises, buildings, or restricted areas. Biometric authentication is also prevalent in mobile devices. For example, smartphones and tablets adopt fingerprint recognition, facial recognition, or iris scanning to unlock devices, authorize app installations, or facilitate secure mobile payments.

Credential-based authentication, also known as token-based authentication, is another category of authentication solutions and relies on the use of a credential to verify the identity of a user. A credential is generated and issued to the user by the system or server after a successful registration process. The credential serves as a proof of authentication and is typically a unique and encrypted string of characters. Credential-based authentication is compatible with different operating systems, web browsers, and application frameworks, making it a versatile choice for authentication in diverse environments. Credential-based authentication allows for stateless authentication, meaning that the server does not need to maintain session state, making it suitable for scalable and distributed systems. The credential-based authentication systems include JSON Web Tokens, OAuth 2.0, SAML (Security Assertion Markup Language), and Security Tokens Service (STS). In addition, to prevent the identity leakage in credential-based authentication, one of its extensions is anonymous credential-based authentication which integrates with zero-knowledge proofs to facilitate the user to generate a proof of the validity of the credential to prove the authorization of the system without directly exposing the credential.

Cross-domain authentication is another category of authentication solutions and offers efficient identity management that authenticates users for services or systems that run on different domains. As the typical application, SSO simplifies the login process by allowing users to access multiple applications or services with a single set of credentials. Instead of requiring users to authenticate separately for each service, SSO facilitates users to log in once and gain access to multiple resources seamlessly. SSO finds applications in various domains, including enterprise environments, web portals, cloud-based services, educational institutions, healthcare systems, mobile applications, and federated identity management. SSO can enhance user experience, reduces the burden of remembering multiple credentials, and improves productivity by eliminating the need for repetitive logins. Additionally, SSO can enhance security by centralizing authentication and enabling organizations to enforce stronger access control policies, ensuring secure access to shared resources.

However, existing solutions have weaknesses and limitations if they are deployed for secure V2X communications. In password-based authentication, the passwords of different services are hard to memorize, and drivers cannot safely input username or password for authentication while driving. Although the vehicles have the capability to maintain the passwords of various services for a driver, there's a significantly high risk of the stored pairs being disclosed. The risk of the password being disclosed also compromises two-factor authentication, which makes it to be conventional token-based authentication.

Certificate-based authentication does require a robust public key infrastructure (PKI) to manage the issuance, revocation, and validation of certificates. It involves the setup and maintenance of trusted CAs and the distribution of certificates to users or devices. Although identity-based encryption can mitigate or eliminate the cost on the certificate management, it brings another issue of key escrow, that is, the key generation center knows the privacy keys of all users. Certificateless authentication may further address key escrow, but it suffers from distribution overhead of the secret keys chosen by users. In addition, blockchain-based certificate management can save the cost on certificate validation and revocation, but an extra blockchain infrastructure is required for certificate maintenance. Further, the open problems of scalability and storage consumption of blockchain are challenging.

Biometric authentication faces several challenges for it to be implemented on vehicles. First, environmental factors such as extreme temperatures and vibrations can impact the accuracy of biometric sensors, potentially leading to authentication failures. Second, there are significant and elevated security concerns or dangers with sharing of personal biometric data with vehicle systems because biometric data is unique to individuals and unchangeable. Additionally, the cost, complexity, and legal considerations related to the use of biometric data in vehicles are further challenges that need to be addressed.

While credential-based authentication is simple and easy to use, it may be vulnerable to credential theft and leakage. If an attacker gains access to user credentials, they can impersonate the user and potentially gain unauthorized access to systems or sensitive information. Additionally, credential-based authentications lacks granularity, which means that credential-based authentication often verifies the overall user identity, rather than specific attributes or roles. This lack of granularity may limit the ability to implement fine-grained access control. Anonymous credentials extend the application scenarios of credential-based authentication, in which identity privacy is one of primary concerns. Anonymous credential-based authentication may limit the capabilities of accountability and revocation. Attackers could exploit anonymity to engage in illegal activities or circumvent security measures, making it challenging to trace their actions back to their real identity.

SSO has the main drawback of a single point of failure. The set of credentials is compromised if the identity server that issues and manages credentials is corrupted. Thus, auditing the behaviors of the identity server to identify potential threats becomes necessary. However, the complexity of implementing and managing SSO across different platforms and applications is challenging. Organizations need to ensure compatibility and seamless integration with various systems, which may require additional resources and effort. Furthermore, user privacy concerns may arise as SSO involves the sharing of authentication credentials across multiple services, potentially raising questions about data protection and user tracking. Finally, current SSO facilitates cross-domain identity authentication, but it does not support the verification of the services, i.e., whether the user is authorized to access the requesting service. Because a service provider can provide multiple services to users, integrating the service authentication with identity authentication becomes important.

According to one or more aspects, efficient and privacy-preserving solutions may be provided to deal with authentication issues among service providers, edge servers, and users in edge-enabled V2X services, considering the increasing number of V2X services.

According to an aspect, an anonymous credential may be created for a service provider that can deal with various V2X on-board services. The anonymous credential may be created by a service provider and may facilitates a vehicle user to access different V2X services offered by different service providers without exposing the user's real identity, so that management of the anonymous credentials is mitigated in scope or effort (lightweight) for the user.

According to an aspect, a vehicle user and an edge server may be anonymously authenticated, wherein the edge server offers the service that the vehicle user requests to access. According to an aspect, the edge server may decide whether the vehicle user is delegated to access their requesting service based on an anonymous credential without interacting with the service provider who generates the credential.

According to an aspect, trust may be built between service providers and an SSO identity server to ensure that the identity server's malicious behaviors can be traced. According to an aspect, false authentication results returned by the identity server may be identified to enforce that the identity server returns correct authentication results.

According to an aspect, a method of cross-domain authentication may be provided in edge-enabled V2X services based on anonymous credential-based authentication and SSO.

According to an aspect, an anonymous credential generation protocol based on Pointcheval and Sanders (PS) signature may be provided that facilitates the generation of identity credentials and service credentials for edge-enabled V2X services. Identity credential may refer to a piece of evidence that confirms an individual's claimed identity. Service credential may refer to a piece of evidence that confirms the claimed access capability or authorization of an individual

According to an aspect, the identity credential may be created by the identity server who manages vehicle user identity. Vehicle user identity may refer to an entity used to identify a vehicle user on a website, software, system or within a generic information technology (IT) environment. The service credentials may be credentials created by the service providers for the authorization of service access.

According to an aspect, a method may be provided that can aggregate the identity credential and the service credentials belonging to the same vehicle user to create a unique and constant size credential, for reducing the cost on the credential management for the identity server. Because the service provider controls the service access delegation for each user, use of service credentials may allow for fine-grained authentication.

According to an aspect an authentication process may be provided that facilitates an edge server, which has been authorized by the service provider, to serve the users. The users which have subscribed to the requesting service from the service provider may access a service through the edge server.

The identity server may handle the verification of users' identities and services based on the vehicle user credentials it has, such that the overhead of the edge server on identity and service authentication is migrated to the identity server. Alternatively, the edge server can check the identity of the vehicle user before forwarding the authentication request to the identity server. By integrating zero-knowledge proof, the edge server may determine the requesting service type without learning or knowing about the user's identity. Further, by integrating zero-knowledge proof, the identity server may determine the user's identity without learning or knowing about the requesting service type. Thus, as long as the identity server does not collude with the edge server, the service preferences to or of a particular vehicle user may remain unknown or may be unlinked, with significantly high confidence.

According to an aspect, blockchain technology may be used to build trust between service providers and the SSO identity server by allowing auditing of the authentication results returned by the identity server. To facilitate the transparency of auditing, the correctness of the authentication results can be publicly verified and the blockchain nodes can be recruited to check and show their votes. If the identity server returns a false result, the blockchain nodes can detect the incorrectness and publish the witness. The blockchain nodes, however, cannot learn information about the credentials during auditing, so that the privacy of users is uncompromised, and the credentials of users can still be used for future authentication.

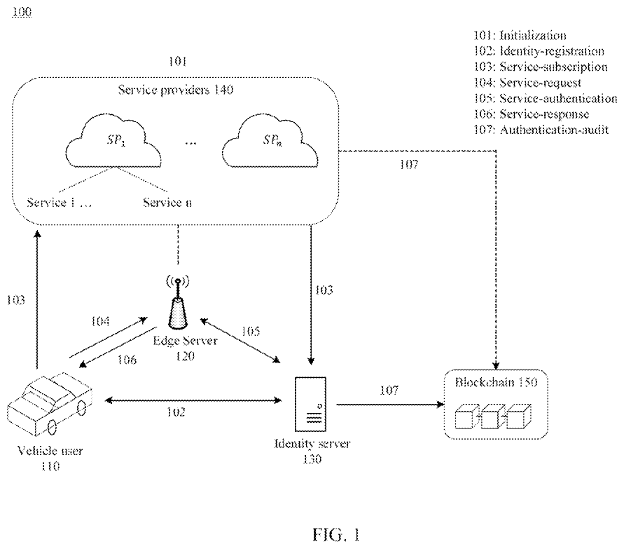

FIG. 1 illustrates a system architecture, according to an embodiment. The system architecture 100 is a system model or network scenario in which methods, systems and apparatus described herein may be performed or implemented according to one or more aspects. The system architecture 100 may comprise one or more of: vehicle user or user 110 (which may be or include an electronic device representative of or used by a human user such as a driver), service provider(s) (SP) 140, identity server (IS) 130, edge server (ES) 120, and blockchain network (or blockchain node(s)) 150.

A service provider (e.g., SPᵢ) belonging to the set of service providers 140 may be a party that has large computing and storage resources and independently offers a set of V2X services to users 110 (i.e., vehicles in V2X). Each service provider SPᵢ may be a different service provider. Different service providers may be in different independent trust domains, which means that they have their individual groups of registered vehicle users. In addition, a single service provider may offer different services to vehicle users, such as high-dimension map and popular multimedia contents, and each service may be independently registered. For example, Google™ provides multiple services to users, and each service, such as Gmail™, may be registered separately and accessed explicitly by the registered users with Google™ accounts. To secure the V2X services, a service provider may be configured to authorize vehicle users 110 to service access through service registration and revoke service access rights of vehicle users.

An identity server (IS) 130 may be a party (e.g., networked electronic server device) that is in charge of vehicle user identity registration and management. The identity server 130 may also be delegated to manage vehicle user service credentials and designed to help the edge server 120 execute service authentication. The identity server 130 can be a centralized server, or a set of decentralized servers jointly managed by a vehicle-related organization, such as an organization of all vehicle manufacturers. The identity server 130 also can be one of the service providers that are reliable and always available, such as Google™ or Facebook™.

An edge server (ES) 120 may be a party (e.g., networked electronic server device) that is deployed by the service provider(s) 140 or edge infrastructure provider(s) to provide the allocated V2X services for valid users after identity authentication and service authentication. Edge servers 120 may refer to the pre-deployed multi-access edge computing (MEC) infrastructure, such as base stations, roadside unit (RSU), and local V2X servers. The edge server 120 may have storage space to cache the service data for V2X services to support efficient content access and computing capabilities to perform computing tasks of V2X services allocated by the service providers or the vehicle users.

A vehicle user (or user) 110 may be a party, or their representative device, that accesses the V2X services on the road. The vehicle user 110 may register its identity on the identity server and subscribe to the interested services on or via the service providers. The vehicle user 110 may have limited resources for storage and computing and may request and access the V2X services. If the service content has been cached on the edge servers 120, the vehicle user 110 can retrieve the requested content from the edge servers 120. Otherwise, the vehicle user 110 may retrieve the content from the service providers 140.

A blockchain node may be a party that participates in a blockchain network 150 to validate identity authentication and service authentication. This blockchain network 150 can be Bitcoin™ blockchain, Ethereum™ blockchain, or Hyperledger™ or other blockchain networks as may be appreciated by a person skilled in the art. The blockchain nodes may run the blockchain consensus protocol, maintain anonymous credentials, and audit the authentication results of the identity server 130. The blockchain nodes may compare the validity of authentication results with the returned results produced by the identity server 130 to identify any misbehavior of the identity server.

The network scenario 100 may be based on a security model which considers a number of security threats and assumptions. For example, the service provider(s) 140 may be fully trusted to authorize and provide V2X services to vehicle users 110 because of monetary benefits. The service provider(s) 140 may operate to honestly maintain their reputation and attract more vehicle users, but the service provider(s) 140 may also be curious about the vehicle users that access their services frequently. For example, the service provider(s) 140 may be interested in the identity of the vehicle user(s) to know who is accessing the service(s).

The identity server 130 manages the identities and service credentials of the vehicle users 110. The curious identity server (which may refer to the owner of the identity server who programs and uses the identity server accordingly) may be interested in what services each vehicle user subscribes to. Moreover, the malicious identity server may return false service authentication results to mislead the edge server's behaviors on service responses. Curiosity, maliciousness, etc. may be attributes of a human or business entity having control of a device such as a server. Anticipating that such a device may potentially be programmed or operated accordingly, embodiments operate to mitigate undesired information flow such as privacy breaches.

The edge server 120 may honestly execute the service authentication process and respond to vehicle user's service request for monetary benefits. However, the edge server 120 may be curious about users' privacy, like the real identity and the services that the users have subscribed to. The edge server 120 may be allowed to know which service a vehicle user requests to access but should have no knowledge about the other services that the vehicle user has subscribed to. This may be to mitigate leakage of non-essential information.

The vehicle user 110 may access the subscribed services by using its credential, but it may also attempt to access services that the vehicle user has not subscribe to by generating invalid service requests or directly replaying service requests of subscribed users.

In some cases, there may exist an external attacker who can compromise multiple unregistered vehicle users and control them to send numerous invalid service requests to an edge server for service authentication. As a result, the resources of the edge server and the identity server may be occupied by those malicious service authentication requests, and the edge server might accordingly not be able to adequately attend to the service authentication requests from valid users.

According to an aspect, a method of cross-domain anonymous authentication in edge-enabled V2X services (e.g., for service providers) may be provided. An edge server 120 that provides V2X services allocated by a service provider (e.g., SP₁) can rely on an identity server 130 to handle identity authentication and service authentication without directly interacting with the service provider.

According to an aspect, referring again to FIG. 1, a method for generating anonymous credential may be provided. The method may include a service provider 140 and an identity server 130 initializing 101 an authentication system. The method may further include a vehicle user 110 registering 102 on the identity server 130 and obtaining an identity credential. The method may further include the vehicle user 110 subscribing 103 to services offered or provided by service provider 140 with their identity credential and the service provider 140 creating service credentials and sending them to identity server 130.

The method for generating anonymous credential may be executed by and among the vehicle user 110, the identity server 130, and the service provider 140 to create an anonymous credential for the vehicle user 110 to access a V2X service offered by the service provider 140. The anonymous credential of a vehicle user 110 may be maintained by the identity server 130 after being created. The anonymous credential of a vehicle user 110 may be aggregated from two parts: an identity credential created by the identity server 130 in identity registration 102 and one or more service credentials created by the service provider 140 in service subscription 103. The anonymous credential may be generated under the request of the vehicle user 110. The size of the anonymous credential may be constant, and may not necessarily be linearly proportional to the number of the services authorized by the service provider 140.

According to an aspect, a method for identity and service authentication may be provided. The method may include a vehicle user 110 requesting 104 to access a certain service on an edge server 120. The method may further include the identity server 130 performing identity and service authentication 105 under the request of the edge server 120. The method may further include the edge server 120 responding 106 to user's request for the service if the vehicle user passes authentication performed by the identity server 130, and rejecting user's request for the service if vehicle user fails to pass identity server 130 authentication.

The method for identity and service authentication may be executed by and among the vehicle user 110, the identity server 130, and the edge server 120 to facilitate the vehicle user 110 to authenticate itself to the edge server for accessing the V2X service offered by the edge server. The authentication may comprise one or both of: identity authentication and service authentication. The identity authentication may be executed between the vehicle user 110 and the edge server 120 or the identity server 130, and the service authentication 105 may be executed between the vehicle user 110 and the identity server 130. The anonymity may be preserved. That is, the edge server 120 may only know the service that the vehicle user requests to access and may not know the identity of the vehicle user; and the identity server 130 may only know the identity of the vehicle user that requests access but may not know the requested service. The identity server 130 may provide the authentication results and inform the edge server 120 whether the requesting vehicle user is authorized to access the service.

According to an aspect, a method for authentication result auditing 107 may be provided, which may include identity server publishing service authentication transcripts on a blockchain 150 for authentication result auditing. The method for authentication result auditing may be executed by and among the identity server 130 and the nodes of a blockchain 150, which can verify the correctness of the authentication results given by the identity server. The correctness of the authentication results can be publicly verified, and the blockchain nodes may be recruited to check the authentication results and show their votes. The blockchain 150 can ensure the fairness of the auditing process and evaluate the trustworthiness of the identity server 130. In the auditing procedure, the anonymous credentials may be required to be kept confidential and not disclosed to the blockchain nodes or any other party.

According to an aspect, a method for generating anonymous credential may be provided. The method may comprise one or more of: system initialization, identity registration, and service subscription.

System initialization may be executed by the identity server 130 and the service provider 140 to bootstrap the system environment. The system parameters may be selected by the identity server and made public to everyone. The identity server and the service provider may independently generate associated public and private key pairs. A public key may refer to a large numerical value used to encrypt data or verify signatures generated by the corresponding private key. A private key may be a cryptographic key used with a public key cryptographic algorithm. The private key may be uniquely associated with the owner and is not made public. The public keys may be published, and the private keys may be kept secret.

Identity registration may be executed by the vehicle user 110 and the identity server 130. According to an aspect, the vehicle user 110 may send a request to register at the identity server, the request including the vehicle user's identity and a commitment. The identity server 130 may create an identity credential from the commitment by utilizing the Pointcheval and Sanders (PS) signature. This credential can be used by the vehicle user to prove its qualification to subscribe to services from other service providers and prove the vehicle user's identity for identity authentication.

Service subscription 105 may be executed by the vehicle user 110, the identity server 130, and the service provider 140. If the vehicle user 110 is interested in a service offered by the service provider, the vehicle user 110 may send the identity credential created by the identity server to the service provider 140 for subscribing to the service. The service provider 140 may create a service credential for responding to the vehicle user's service request and forward the service credential to the identity server 130. The identity server 130 may aggregate the new service credential with the current anonymous credential of the vehicle user to produce a new anonymous credential (or aggregated anonymous credential). The new anonymous credential of the vehicle user may be maintained by the identity server 130.

System initialization 101 may involve a method to initialize the system and produce the system parameters for the identity server 130 and the service providers 140. In some embodiments, there can be one identity server and multiple service providers. These service providers may utilize the authentication service offered by the identity server to obviate the need to manage vehicle user credentials and handle authentication requests. Accordingly, a method for initializing the system 100 may be provided. FIG. 2 illustrates a method 200 for initializing a system for cross-domain authentication, according to an aspect.

The method 200 for initializing a system for cross-domain authentication may include the identity server 130 bootstrapping the authentication system by generating 201 system parameters [symbol] . Given a type-3 pairing-group generator G and 1^{λ}, the identity server may generate Γ={p, [symbol] e}←G(1^{λ}). The bilinear groups [symbol] may be a set of three cyclic multiplicative groups of a prime order p, where 2^{λ}≤p≤2^{λ+1}, along with a bilinear map e: [symbol] . A cyclic multiplicative group may be a set of elements along with a binary operation (e.g., multiplication) that satisfies specific properties. The subscripts “1,” “2,” and “T” indicate that these are three different groups. In some embodiments, a cyclic group may be a mathematical structure where there is a special element (e.g., the generator) that, when repeatedly operated on with the binary operation, generates all the elements of the group. The prime order p indicates that each of the three cyclic multiplicative groups has a specific number of elements, and this number is a prime number p.

A bilinear map may be a function that takes pairs of elements from two different groups and maps them to an element in a third group. In this case, the bilinear map “e” takes pairs of elements from G₁ and G₂ and maps them to elements in G_{T}. The bilinear map may have a special property, i.e., it is bilinear, which means that it preserves certain algebraic properties between the groups, as will be readily understood by a worker skilled in the art.

As may be appreciated, the security parameter “λ” is a value that represents the level of security desired or required in a cryptographic scheme or protocol. It is a parameter that can be adjusted to influence the strength of the cryptographic primitives used and the overall security of the system. The value of “λ” may determine the level of security that the cryptographic scheme aims to achieve. A larger value of “λ” typically corresponds to a higher level of security. The relationship between “λ” and security may be exponential, meaning that increasing “λ” results in a significant increase in security.

According to an aspect, [symbol] and [symbol] may be denoted as [symbol] and [symbol] = [symbol] , which may indicate that [symbol] and [symbol] are denoted as the cyclic subgroups of G₁ and G₂ respectively, excluding the identity elements 1_{G}_{₁} and 1_{G}_{₂}. The hash functions may be defined as H:{0,1}*→ [symbol] and H₁: [symbol] . Thus, H may be a hash function that takes binary input and produces an integer output in the range of Zₚ (integers modulo p, where “p” is a prime number). H₁ may be another hash function that takes elements from G₁ and maps them to integers in Zₚ.

Thus, the system parameters may be [symbol] ={p, [symbol] , H, H₁}. The system parameters may be made publicly available by the identity server after generation.

The method 200 may further include, generating 202, by the identity server, private and public keys. In an embodiment, the identity server 130 may randomly select

$$g {←}^{\$} {𝔾}_{1}^{⋆} , \tilde{g} {←}^{\$} {𝔾}_{2}^{⋆} , and ( x , y ) {←}^{\$} {ℤ}_{p}^{2} .$$

The identity server 130 may compute (X, Y)=(g^{x}, g^{y}) and (\tilde{X}, \tilde{Y})=(\tilde{g}^{x}, \tilde{g}^{y}). As previously mentioned, $ means that the value is randomly chosen from the group. The private key of the identity server may be X and the corresponding public key is (g, Y, \tilde{g}, \tilde{X}, \tilde{Y}).

Accordingly, the random element (value, parameter or variable) g may be chosen from the cyclic subgroup [symbol] . The random element \tilde{g} may be chosen from the cyclic subgroup [symbol] . The two random integers x and y may be chosen from the set of integers modulo “p”, [symbol] .

The private key may be secretly stored on the identity server and the public key may be made available to the public. The public key may further be registered on the public key infrastructure to obtain the public key certificate. A certificate may be known as a public key certificate or an identity certificate, which may be understood to be an electronic document or information used to prove the validity of a public key.

The method 200 may further include each service provider, e.g., SPᵢ, generating 203 its own public key (\tilde{Y}_{ι}) and private key (yᵢ). In an embodiment, each service provider (e.g., SPᵢ) may randomly select

$${y}_{i} {←}^{\$} {ℤ}_{p}$$

and compute \tilde{Y}_{ι}=\tilde{g}^{y}^{ᵢ}. Accordingly, the private key of each service provider (e.g., SPᵢ) may be yᵢ and the corresponding public key is \tilde{Y}_{ι}.

The private key may be secretly stored on the service provider and the public key may be made available to the public. The public key should be registered on the public key infrastructure to obtain the public key certificate.

According to an aspect, identity registration 102 may be performed when a vehicle user 110 determines to request services from a service provider. Before requesting the service, the vehicle user 110 may need to request the identity credential from the identity server 130. Because the identity server 130 can be one of the servers of a well-known service provider, such as Google™ or Apple™, or an automobile manufacturer, identity registration may be initialized by the vehicle user 110 to subscribe to the service from the popular service provider or register the vehicle at the manufacturer. According to an aspect, identity registration 102 may be performed before a specific service subscription.

FIG. 3 illustrates a method 300 for identity registration, according to an embodiment. The method 300 may further allow for generation of identity credential for a vehicle user. Method 300 may include a vehicle user (or user) 110 randomly selecting 302 secret values

$$v {←}^{\$} {ℤ}_{p} and r {←}^{\$} {ℤ}_{p}$$

and computing a commitment of v as C=g^{r}Y^{v}. As noted, v may be a random value chosen from the group Zₚ and may be considered as a private key of the user. Value r may be a random value chosen from the group Zₚ and is used to randomize the commitment parameter C.

As mentioned, the commitment parameter C may be computed using a function (e.g., C=g^{r}Y^{v}) that combines the random values r and v in a way that is one-way and computationally difficult to reverse. This may facilitate that it is practically infeasible to determine the original values from the commitment parameter. Once the commitment parameter C is generated, C is used to “commit” the values r and v. Thus, the values r and v may be associated with the commitment parameter C in a secure and irreversible manner.

The method 300 may further include the vehicle user 110 selecting 304 secret values

$$t {←}^{\$} {ℤ}_{p} and a {←}^{\$} {ℤ}_{p}$$

and computing T=at. Thus, parameter T may be generated based on random values a and t. Parameter T may be used for re-signing service credentials for aggregation. The value a is the random value to randomize t, and t is the random value to generate the aggregated anonymous credential (or anonymous credential) as described herein. It is noted that selections 302 and 304 can be performed randomly, i.e. according to a randomized or pseudo-randomized operation. Other random value selections can be performed similarly.

The method 300 may further include the vehicle user 110 sending the message {ID, C, T} 306 to the identity server 130 through a secure channel for identity registration, where ID is the identity of the vehicle user. The message {ID, C, T} 306 may be sent as part of a request message to the identity server 130 for identity registration and requesting an identity credential. As may be appreciated, the vehicle user may perform operations 302 and 304 in one or more steps.

The vehicle user 110 may further send a proof transcript (T_{C}, r′, v′) 308 indicating ownership of r and v to the identity server 130. The vehicle user 110 may prove the ownership of r and v based on a non-interactive zero-knowledge proof:π←NIZK{(r, v):C=g^{r}Y^{v}}. The proof process may include the vehicle user 110 randomly choosing ρᵣ,

$${ρ}_{v} {←}^{\$} {ℤ}_{p}$$

and computing T_{C}=g^{ρ}^{ᵣ}Y^{ρ}^{ᵥ}. The proof process may further include the vehicle user 110 computing c=H₁(T_{C}). The proof process may further include the vehicle user 110 computing r′=ρᵣ−cr and v′=ρᵥ−cv.

Thus, the vehicle user 110 may send the proof transcript (T_{C}, r′, v′) 308 to the identity server 130, along with the message {ID, C, T} 306. In some embodiments, message 306 and the proof transcript 308 may be sent in one message. The messages 306 and 308 may be or include a request for an identity credential, C_{id}, e.g. messages 306 and 308 may constitute a request message.

The method 300 may further include the identity server 130 parsing 310 the received message and obtaining the commitment parameter C. The identity server 130 may further verify 312 the ownership of r and v through NIZK by testing if c=H₁(g^{r}′Y^{v}′C^{c}). If the equation holds, the identity server may continue to perform one or more operations 314. Otherwise, the identity server 130 may abort and return a failure indication to the vehicle user 110.

If the identity server 130 verifies the ownership of r and υ (i.e., the equation holds), the method 300 may further include the identity server generating 314 signature σ′. Generating the signature σ′ may include the identity server 130 selecting a random

$$u {←}^{\$} {ℤ}_{p}$$

and signing C as σ′=(g^{u}, (XC)^{u}). The value u may be a random value chosen from Zp

$$( u {←}^{\$} {ℤ}_{p} )$$

and used to generate the identity credential C_{id}.

The method 300 may further include the identity server 130 returning to the vehicle user 110 the generated signature σ′ 316 through the secure channel. The generated signature σ′ is usable by the vehicle user 110 to obtain the identity credential C_{id}. The identity server 130 may further store {ID, σ′, T}.

The method 300 may further include the vehicle user 110 obtaining 318 the identity credential. Obtaining the identity credential may include the vehicle user 110 parsing σ′ as

$$( {σ}_{1}^{′} , {σ}_{2}^{′} )$$

and unbinding it by computing

$$σ = ( {σ}_{1} , {σ}_{2} ) = ( {σ}_{1}^{′} , {σ}_{2}^{′} / {σ}_{1}^{′ r} ) = ( {g}^{u} , {g}^{u ( x + y v )} ) .$$

σ may be described as the identity credential C_{id} of the vehicle user 110.

According to an aspect, method 300 may be combined with method 200.

Service subscription 103 may be initialized by the vehicle user 110 to subscribe to a service provided by a service provider 140. According to an aspect, with the identity credential obtained from the identity server 130, the vehicle user 110 may send a subscription request to the service provider 140, and the service provider 140 may generate or create a service credential based on the subscribed service for the requested user. The anonymous credential may be generated by aggregating the identity credential created by the identity server and the service credentials created by the service provider for the vehicle user. The anonymous credentials may be maintained by the identity server 130. As a service provider may provide multiple services, the vehicle user 110 may request a service credential for each service when needed and the identity server 130 may aggregate the new service credential with the existing anonymous credential to generate a new one.

FIG. 4 illustrates a method for subscribing to one or more services, according to an embodiment. The method 400 may include a vehicle user 110 sending a request 402 to a service provider (e.g., SPᵢ) 140 to subscribe to a service. For example, when the vehicle user 110 is willing to subscribe a service sᵢ, offered by the service provider 140, the vehicle user 110 may generate a parameter \tilde{Y}^{v} and send the message (ID, σ, \tilde{Y}^{v}, a, sᵢ) 402 to the service provider 140 through a secure channel for service subscription. In message 402, σ may refer to the identity credential of the user, sᵢ may refer to an indication of the service provider by the service provider 140 (SPᵢ), and the other parameters refer to the same parameters defined herein.

The method 400 may further include the service provider 140 parsing 404 the received message and obtaining or extracting the identity credential σ of the vehicle user 110. The method 400 may further include, the service provider 140 verifying 406 the validity of σ through computation of the verification equation e(σ₁, \tilde{X}\tilde{Y}^{v})=e(σ₂, \tilde{g}). If the equation holds, the service provider 140 may then generate 408 a service credential associated with the service sᵢ, otherwise, the service provider 140 may abort and return failure.

If the vehicle user 110 is a registered user on the identity server 130, the method 400 may include the service provider 140 generating 408 the service credential Cₛ_{ᵢ} for the service. Generating the service credential may include selecting a random value

$${t}_{i} {←}^{\$} {ℤ}_{p}$$

and signing σ to generate a new signature (σ_{i,1}, σ_{i,2})=(σ₁^{t}^{ᵢ},(σ₂σ₁^{y}^{ᵢ}^{H(s}^{ᵢ}⁾)^{t}^{ᵢ})=(g^{ut}^{ᵢ}, g^{ut}^{ᵢ}^{(x+yv+y}^{ᵢ}^{H(s}^{ᵢ}⁾⁾). This new signature σᵢ is the service credential Cₛ_{ᵢ} about the service sᵢ for the vehicle user. Here, σ_{i,1}, σ_{i,2} are components of the signature σᵢ; yᵢ is a private key of the service provider 140 and is randomly generated according to

$${y}_{i} {←}^{\$} {ℤ}_{p} ;$$

tᵢ is a random variable generated according to

$${t}_{i} {←}^{\$} {ℤ}_{p} ;$$

and the other parameters are the similar parameters as defined herein.

The method 400 may further include the service provider 140 computing Tᵢ=atᵢ and sending a message {ID, σᵢ, Tᵢ} 410 to the identity server 130 through a secure channel for service credential management (e.g., to manage one or more credential of the vehicle user). The ID may refer to the identifier of the vehicle user 110. The parameter Tᵢ may be used for signing service credentials. The value a may be a random value generated according to:

$$a {←}^{\$} {ℤ}_{p}$$

and is used to randomize parameter tᵢ. The parameter tᵢ may be a random value generated according to:

$$a {←}^{\$} {ℤ}_{p}$$

and may be used to generate the service credential. The message {ID, σᵢ, Tᵢ} 410 may be request message requesting to generate an anonymous credential for the vehicle user.

The method 400 may further include, the service provider 140 generating 412 a proof transcript using a non-interactive zero-knowledge (NIZK) proof to prove validity of the signature σᵢ. In an embodiment, the service provider 140 may prove the validity of the signature σᵢ by using the non-interactive zero-knowledge proof, where the service sᵢ that the vehicle user 110 subscribes cannot be exposed to the identity server 130: π←NIZK{(sᵢ):e(σ_{i,1}, \tilde{X}\tilde{Y}^{v}\tilde{Y}ᵢ^{H(s}^{ᵢ}⁾)= e(σ_{i,2}, \tilde{g})}. Accordingly, the NIZK proof may be performed such that the privacy of service sᵢ is preserved.

In an embodiment, the proof process (e.g., generating the proof transcript) may include the service provider 140 randomly choosing

$${ρ}_{{s}_{i}} {←}^{\$} {ℤ}_{p} ,$$

and computing

$${T}_{{σ}_{i}} = e {( {σ}_{i , 2} , {\tilde{Y}}_{i} )}^{{ρ}_{{s}_{i}}} .$$

Here, ρₛ_{ᵢ} is a random variable generated according to

$${ρ}_{{s}_{i}} {←}^{\$} {ℤ}_{p} ,$$

and \tilde{Y}ᵢ is a public key of the service provider and is generated according to: \tilde{Y}ᵢ=\tilde{g}^{y}^{ᵢ}, the service provider providing the service indicated by sᵢ.

The proof process may further include, the service provider computing c=H₁(T_{σ}_{ᵢ}), where H₁ is a hash function as described herein. The proof process may further include, the service provider computing

$${s}_{i}^{′} = {ρ}_{{s}_{i}} - c H ( {s}_{i} ) .$$

The method 400 may further include, the service provider 140 sending the proof transcript

$$( {T}_{{σ}_{i}} , {s}_{i}^{′} )$$

414 to the identity server 130. In some embodiments, the service provider 140 may send the proof transcript along with the message {ID, σᵢ, Tᵢ} 410.

The method 400 may further include, the identity server 130 verifying 416 the validity of the signature σᵢ through NIZK. For example, the identity server 130 may verify the validity of the signature σᵢ by testing if

$$c = {H}_{1} ( e {( {σ}_{i , 1} , \tilde{Y} )}^{v ′} {( \frac{e ( {σ}_{i , 2} , \tilde{g} )}{e ( {σ}_{i , 1} , \tilde{X} \tilde{{Y}^{v}} )} )}^{c} ) .$$

Here σ_{i,1}, σ_{i,2} are components of the signature σᵢ; and the other parameters are the same parameters as described herein (e.g., v′ is a component of a proof transcript of the vehicle user as described herein, v′=ρᵥ−cv; c=H₁(T_{C}); T_{C}=g^{ρ}^{ᵣ}Y^{ρ}^{ᵥ}, where ρᵣ, ρᵥ are randomly generated according to: ρᵣ,

$${ρ}_{v} {←}^{\$} {ℤ}_{p} ;$$

and v is a value randomly generated according

$$v {←}^{\$} {ℤ}_{p} ) .$$

If the equation,

$$c = {H}_{1} ( e {( {σ}_{i , 1} , \tilde{Y} )}^{v ′} {( \frac{e ( {σ}_{i , 2} , \tilde{g} )}{e ( {σ}_{i , 1} , \tilde{X} \tilde{{Y}^{v}} )} )}^{c} )$$

holds, the method 400 may further include the identity server 130 generating or computing 418 σᵢ′=(σ_{i,1}′, σ_{i,2}′)=(σ_{i,1}^{T/T}^{ᵢ}, σ_{i,2}^{T/T}^{ᵢ})=(g^{ut}, g^{ut(x+yv+y}^{ᵢ}^{H(s}^{ᵢ}⁾⁾). Otherwise, the identity server may abort and return a failure to the service provider 140. As described herein, T=at, where t is a random value generated according to

$$t {←}^{\$} {ℤ}_{p} ;$$

u may be a random variable generated according to

$$u {←}^{\$} {ℤ}_{p} ;$$

and yᵢ refers to a private key of a service provider (e.g., SPᵢ) of the service and is randomly generated according to

$${y}_{i} {←}^{\$} {ℤ}_{p} .$$

The method 400 may further include, the identity server 130 generating 420 an anonymous credential σ_{S} for the vehicle user 110 based on the signature σᵢ. Generating the anonymous credential σ_{S} may include aggregating {σᵢ′}, i∈S, where S is the set of the indices of the services subscribed by the vehicle user 110, to generate an anonymous credential σ_{S} with a constant size σ_{S}=(σ_{S,1}, σ_{S,2})=(σ_{i,1}′, Π_{i,i∈S}σ_{i,2}′)=(g^{ut}, g^{utΣ}^{_{i,i∈S}}^{(x+yv+y}^{ᵢ}^{H(s}^{ᵢ}⁾⁾) and subsequently storing it for service authentication.

In some embodiments, the method 400 may be combined with one or more of: the method 300 and the method 200. The one or more methods 200, 300 and 400, related to anonymous credential generation protocol, may facilitate reduced overhead as the vehicle user(s) is relieved of management overhead related to service credentials. The vehicle user may only need to maintain one identity credential to access different services offered by different service providers. This identity credential might only relate to the identity of the vehicle user and not to the subscribed services. To subscribe to a new service, the vehicle user may not need to maintain a credential for that service. Accordingly, the management of the credentials on the user side may be simplified.

The one or more methods 200, 300 and 400, related to anonymous credential generation protocol, may allow for constant size of anonymous credential for the identity server: The identity server 130 may create the identity credential for the vehicle user 110 and aggregates it with the received service credentials to generate the anonymous credential for the vehicle user. The anonymous credential may have a constant size, so that the storage cost of the identity server is reduced. Further, the constant size of the anonymous credential may be non-linear to the number of the subscribed services of the vehicle user. For example, the anonymous credential may conceal (not indicate) the services, or the number of services to which the vehicle user has subscribed, or both.

According to an aspect, an identity and service authentication protocol or method may be provided. The identity and service authentication protocol may comprise one or more of: operations related service request 104, operations related service authentication 105, and operations related service response 106.

Operations related to service request 104 may be executed by the vehicle user 110 to generate the request of service access based on the identity credential and the requested service. A registered user who has subscribed to a service may access the service at any time. The service can be provided by the service provider 140, as well as an edge server 120 who has been authorized by the service provider to offer the service.

Operations related to service authentication 105 may be executed by the vehicle user 110, the edge server 120, and the identity server 130. The authentication verification may be completed with the collaboration of the edge server 120 and the identity server 130. In an embodiment, the edge server 120 may verify the validity of the identity credential of the vehicle user to check whether the user is a registered user. The identity server 130 may verify the validity of the service credential to check whether the vehicle user has subscribed to the requested service. The verification result of the identity server 130 may be returned to the edge server 120 to determine whether to give the vehicle user a service response. Here, the identity server performs the authentication by verifying the identity credential and service credential of the vehicle user, and the edge server relies on the authentication of the identity server to make decision on service access.

Operations related to service response 106 happen after the edge server 120 receives the verification results from the identity server 130. If both the identity credential and the service credential are valid, the identity server 130 may return a positive verification result to the edge server and the edge server may provide the requested service to the vehicle user 110.

The service request may be generated by randomizing the identity credential. The requested service may be given in the request, but the identity of the vehicle user may be hidden. The service request may be sent to the edge server 120 which has been authorized to offer the requested service.

FIG. 5 illustrates a method for identity and service authentication, according to an embodiment. The method 500 may be performed when a vehicle user 110 requests for a subscribed service sⱼ, where sⱼ is an indication of the service. In an embodiment, method 500 may apply when a vehicle user 110 wants to request for a subscribed service sⱼ offered by a service provider (e.g., SPⱼ). Method 500 may include, the vehicle user 110 selecting 502 random values b,

$$d {←}^{\$} {ℤ}_{p}^{2}$$

and randomizing 502 the identity credential C_{id} as \tilde{σ}=(σ₁^{b}, (σ₂σ₁^{d})^{b})=(g^{ub}, g^{ub(x+yv+d)}). Here σ₁ and σ₂ are components of the identity credential σ; b and d are random values generated according to b,

$$d {←}^{\$} {ℤ}_{p}^{2}$$

(for use to randomize the identity credential), and u is a random variable generated according to:

$$u {←}^{\$} {ℤ}_{p} .$$

The method 500 may further include, vehicle user selecting 504 random value f according to

$$f {←}^{\$} {ℤ}_{p}$$

and generating or computing \tilde{g}^{f}, \tilde{Y}ⱼ^{f}, and

$$A = {( \tilde{X} {\tilde{Y}}^{{}_{v}} {\prod }_{i ∈ S , i \neq j} \tilde{X} {\tilde{Y}}^{{}_{v}} {\tilde{Y}}_{i}^{H ( {s}_{i} )} )}^{f} ,$$

Here \tilde{g}^{f} may be a parameter needed by the identity server for service verification. Parameter \tilde{g}^{f} may be generated by the vehicle user and sent to the edge server in the request 506. The edge server may then forward \tilde{g}^{f} to the identity server as described herein. Parameter \tilde{Y}ⱼ^{f} may be generated based on a public key, \tilde{Y}ⱼ, of the service provider 140 (e.g., SPⱼ) providing the service sⱼ. Parameter \tilde{Y}ⱼ^{f} may be needed by the edge server 120 for adding the requested service into a service authentication request to the identity server 130 as described elsewhere herein.

Parameter A may be part of the service request message 506 and may be generated from one or more parameters including the public key of the identity server 130, the public keys of the service providers 140 that the vehicle user 110 has subscribed service from, the private key of the vehicle user, the subscribed services other than the requesting service sⱼ, and the random value f.

The method 500 may further include, the vehicle user 110 sending a service request message 506 to the edge server 120 to request for the service sⱼ. The request message 506 may comprise one or more of: {\tilde{σ}, \tilde{g}^{f}, \tilde{Y}ⱼ^{f}, A, sⱼ, [symbol] }. Parameter [symbol] may refer to the ciphertext of an identifier (ID) of the vehicle user. The request message 506 might only indicate or expose the service that the vehicle user is to access while concealing the vehicle user's real identity and other services to which the vehicle user is subscribed.

Method 500 may further include, the vehicle user 110 sending a proof transcript (T_{\tilde{σ}}, v′, d′) 508 to the edge server 120, along with the service request message {\tilde{σ}, \tilde{g}^{f}, \tilde{Y}ⱼ^{f}, A, sⱼ, [symbol] } 506. The proof transcript 508 and the request message 506 may be sent in one or more messages.

The vehicle user 110 may prove the ownership of v and d through a non-interactive zero-knowledge proof: π←NIZK{(v, d):e(\tilde{σ}₁, \tilde{X}\tilde{Y}^{v}g^{f})=e(\tilde{σ}₂,\tilde{g})}. The proof process may include the vehicle user 110 randomly selecting ρᵥ,

$${ρ}_{d} {←}^{\$} {ℤ}_{p}$$

and computing T_{\tilde{σ}}=e(\tilde{σ}₁, \tilde{Y})^{ρ}^{ᵥ}e(\tilde{σ}₁, g)^{ρ}^{_{d}}. The proof process may further comprise the vehicle user 110 computing c=H₁(T_{\tilde{σ}}). The proof process may further comprise the vehicle user 110 computing v′=ρᵥ−cv and d′=ρ_{d}−cd.

In an embodiment, operations related to service request 104 may include one or more operations described in reference to method 500 including operations related to 502, 504, 506 and 508 as described above.

Service authentication 105 may be performed by the edge server 120 and the identity server 130 that checks the validity of a vehicle user's service request. After receiving the service request, the edge server 120 may be responsible for verifying the randomized identity credential. The edge server 120 may then integrate the requested service into a service authentication request and forward it to the identity server 130. The identity server may know the identity of the vehicle user and may check the validity of the service based on its maintained anonymous credential.

According to an embodiment, after receiving the service request 506 and the proof transcript 508 from the vehicle user 110, the edge server 120 may parse 510 the received service request message and obtain or extract the randomized identity credential \tilde{σ}.

The edge server 120 may further verify 512 the validity of the randomized identity credential \tilde{σ} and the ownership of v and d by testing if

$$c = {H}_{1} ( e {( {\tilde{σ}}_{1} , \tilde{Y} )}^{v ′} e {( {\tilde{σ}}_{1} , \tilde{g} )}^{d ′} {( \frac{e ( {\tilde{σ}}_{2} , \tilde{g} )}{e ( {\tilde{σ}}_{2} , \tilde{X} )} )}^{c} ) .$$

If the equation holds (i.e. equality is determined to exist), the edge server 120 may compute or generate 514

$${A}^{′} = A \cdot {\tilde{{Y}_{j}}}^{f \cdot H ( {s}_{j} )} = {( {\prod }_{i ∈ S} \tilde{X} {\tilde{Y}}^{{}_{v}} {\tilde{Y}}_{i}^{H ( {s}_{i} )} )}^{f}$$

and sign it as signₛₖ_{_{ε}}(A′). If the equation does not hold, the edge server 120 may abort and return a failure indication to the vehicle user 110. The purpose of computing A′ is to add the requesting service sⱼ to parameter A, which may allow for achieving service privacy against the identity server 130. The signature of A′ (which may also be referred to as signₛₖ_{_{ε}}(A′)) may be uploaded to a blockchain. The purpose of the signature may be to prevent or inhibit the identity server from uploading a faked request to slander the edge server.

Method 500 may further include, the edge server 120 sending a service authentication request message 516 to the identity server 130. The service authentication request message 516 may comprise one or more of: {A′, signₛₖ_{_{ε}}(A′), \tilde{g}^{f}, [symbol] } to facilitate the identity server 130 to verify whether the vehicle user 110 has been authorized to access the corresponding service.

After receiving the service authentication request message

{A′, signₛₖ_{_{ε}}(A′), \tilde{g}^{f}, [symbol] } 516 from the edge server 120, the identity server 130 may verify 518 the signature of A′ and obtain ID of the vehicle user 110 by decrypting [symbol] . Method 500 may further include, the identity server 130 retrieving 520 the anonymous credential σ_{S} of the vehicle user 110 according to its ID and verifying the σ_{S} by checking whether e(σ_{S,1}, A′)=e(σ_{S,2}, \tilde{g}^{f}). Based on the outcome of computing this equation, the identity server 130 may generate an authentication result indicating whether the vehicle user 110 is authorized to access the service based on the retrieved anonymous credential σ_{S}. The identity server 130 may send to the edge server 120 a service authentication response 522 which includes the authentication result. For example, if the equation (e(σ_{S,1}, A′)=e(σ_{S,2}, \tilde{g}^{f})) does not hold, the identity server 130 may abort and return a reject indication to the edge server 120. Otherwise, the identity server 130 may return a service authentication result including a pass indication to the edge server 120, where the pass indication means that the service authentication succeeded, while the reject indication indicates the service authentication failed.

Accordingly, in an embodiment, operation related to service authentication 105 may include one or more operations described in reference to method 500 including operations related to 510, 512, 514, 516, 518, 520 and 522. The service authentication 105 may be described as the service authentication with the help of the identity server. Method 500 may be combined with one or more of methods 200, 300, and 400.

Operations related to service response 106 may be performed by the edge server 120 to provide the requested service to the vehicle user based on the authentication results 522 of the identity server 130. In an embodiment, if the edge server 120 receives the service authentication result including a pass indication from the identity server, the edge server may find the content of the corresponding service and provide the corresponding service to the vehicle user 110. If the edge server 120 receives a service authentication result including a reject indication from the identity server, the edge server may abort and return a failure to the vehicle user.

Method 500 related to identity and service authentication may allow for improved identity privacy and service privacy. In method 500, the identity of the vehicle user that accesses the service may be hidden from (not disclosed to) the edge server, which may only know the requested service of that vehicle user. Further, in method 500, the requested service of the vehicle user may be hidden from (not disclosed to) the identity server, which may only know who requests the service. Therefore, as long as the identity server and the edge server do not collude, no one entity is expected to learn both identity of a vehicle user and requested service of that vehicle user.

Method 500 may further allow for edge-based V2X service authentication without the service provider. Method 500 may allow for a vehicle user to access a V2X service offered by an edge server after passing service authentication. The edge server may not need to interact with the service provider for service authentication, so that the service provider can be “off-line” after authorizing the service to edge servers.

Method 500 may further allow for cross-domain authentication between service providers. Both identity authentication and service authentication can be handled by the identity server for different service providers. Although service providers may be in different trust domains, they can depend on the identity server to handle the authentication. Accordingly, method 500 may reduce the overhead of service providers for user identity and service management. Further, the vehicle users do not need to input username or password for service access. The vehicle users may only need to maintain their identity credentials and re-use them to access different services provided by different service providers.

According to an aspect, a method or protocol 600 for authentication result auditing (referring to the authentication-audit of 107) may be provided. The method 600 may facilitate public verifiability of the authentication results. To protect the anonymous credentials of vehicle users, while enabling public verifiability, the anonymous credentials may be randomized before broadcasting to the blockchain nodes. The blockchain nodes may be responsible for checking service authentication and determining whether the identity server returns the right results to the edge servers.

FIG. 6 illustrates a method for auditing authentication results of an identity server, according to an embodiment. Method 600 may be combined with one or more of methods 200, 300, 400 and 500.

After service authentication, e.g., referring to after verifying 520 the anonymous credential, method 600 may include, the identity server 130 randomizing the anonymous credential σ_{S} of the vehicle user with randomly selected k,

$$l {←}^{\$} {ℤ}_{p}^{2}$$

and obtaining 602 a randomized anonymous credential \tilde{σ}_{S}=(\tilde{σ}_{S,1}, \tilde{σ}_{S,2})=(σ_{S,1}^{k}, σ_{S,2}σ_{S}_{₁}^{l})^{k}.

Method 600 may further include, the identity server 130 integrating 604, via blockchain 150, authentication information or authentication result data into a transaction and publishing it on a public blockchain, such as Ethereum™. The authentication information or authentication result data may comprise one or more members of the set {σ_{S}, A′, signₛₖ_{_{ε}}(A′), \tilde{g}^{f}, \tilde{g}^{fl}}. The authentication information in the transaction can be utilized to publicly verify the service authentication results by third party auditors, the service providers, and the blockchain nodes.

Method 600 may further include, one or more nodes on the public blockchain or an auditor verifying 606 the authentication result of the identity server. Verifying 606 the authentication result of the identity server may include, the one or more nodes of the public blockchain verifying 608 the signature of A′ to guarantee that A′ comes from the service authentication request 516 of a service-deployed edge server 120. Verifying 606 the authentication result of the identity server may include, the one or more nodes of the public chain verifying 610 the randomized anonymous credential \tilde{σ}_{S} by checking whether the equation e(\tilde{σ}_{S,1}, A′)·e(\tilde{σ}_{S,1}, \tilde{g}^{fl})=e(\tilde{σ}_{S,2}, \tilde{g}^{f}) holds and obtain a verification result based on determining whether the equation holds.

Verifying 606 the authentication result of the identity server may include the one or more nodes of the public chain comparing 612 the above verification result with the service authentication result returned by the identity server. If the two results agree, the service authentication result from the identity server is deemed trustworthy. Otherwise, the service authentication result is considered untrustworthy and the misbehavior of the identity server can be caught or detected.

By randomizing 602 the anonymous credential before publishing it on the blockchain, method 600 may allow the vehicle's anonymous credential to be safeguarded, secured or less vulnerable to unauthorized access or tampering during the service authentication auditing and thus improving security and privacy.

The authentication result auditing protocol 600 may allow for enhanced trustworthiness of the identity server. Because the authentication results can be publicly checked by one or more blockchain nodes, the identity server is inhibited or discouraged to return any false authentication results to the edge servers. This can effectively prevent the misbehaviors of the identity server and enhance trustworthiness. As a result, the service providers can trust the identity server for cross-domain authentication.

The authentication result auditing protocol 600 may allow for enhanced fairness of trust evaluation. The public verifiability of authentication results can effectively promote fairness in trust evaluation. Accordingly, no trusted party may be needed, and the effectiveness of auditing may be reliable or unconditional.

According to an aspect, a cross-domain anonymous authentication architecture 100 for edge-enabled V2X services may be provided. The architecture 100 may be suitable to resolve the challenge of efficient and privacy-preserving authentication among service providers, edge servers, and vehicle users with the aid of the identity server in edge-enabled V2X services.

According to an aspect, an anonymous credential generation protocol (one or combination of methods 200, 300 and 400) may be provided. The anonymous credential of a vehicle user may be derived from the aggregation 420 of the identity credential and the service credentials, which may reduce the cost on credential management and credential verification. As described herein, the anonymous credential generation protocol may aggregate the identity credential created in identity registration and service credentials created in service subscription to produce a unique and constant-size credential for the user.

According to an aspect, an identity and service authentication protocol (also referred to as a method) 500 may be provided. Method 500 leverages the idea of SSO for identity and service authentication, which simplifies authentication between users and edge servers and may enhance user privacy. Method 500 may employ an identity server for identity and service authentication without exposing user identity to the edge server or user's requested service to the identity server.

According to an aspect, an authentication result auditing protocol (also referred to as a method) 600 may be provided. The auditing of the authentication results may enhance the trust between the identity server and the edge servers. This protocol 600 may enforce the identity server to behave honestly and return correct authentication results to the edge servers. Protocol 600 may further facilitate public auditing of authentication results with the aid of blockchain nodes, without exposing anonymous credentials of vehicle users.

According to one or more aspects, the technique of “Single Sign-On” may be leveraged to provide for one or more methods for authenticating a vehicle user and the subscribed service. The one or more methods described herein further leverages anonymous credential which is different than the conventional “Single Sign-On” methods which achieve user authentication based on password.

Anonymous credential-based authentication, which may be based on zero-knowledge proofs, may allow for improved user privacy. In the V2X scenarios, privacy of vehicles is very important, and inputting passwords during driving may be impractical and dangerous. Therefore, anonymous credential-based authentication may be a promising solution. Password-based authentication may become attractive when computational efficiency has the first priority.

As described herein, one or more methods may allow for service authentication at edge servers, which may be an essential feature as edge computing plays a role in future of distributed network architecture. In the one or more methods described herein, the identity server 130 may be exploited to verify the legality or acceptability of vehicle users to access the requested services from the edge servers. The service authentication at edge servers may save and reduce computational overhead for the edge servers and may require some communication between the edge server and the identity server. Verifying a vehicle user and the service request, independently, may be an attractive functionality at the edge servers, e.g., without the help of the identity server or the service providers. This functionality may depend on the computational overhead at the edge servers. If an edge server can perform service authentication efficiently, the edge server may prefer to handle authentication independently, otherwise, recruiting an identity server for service authentication may be a promising solution.

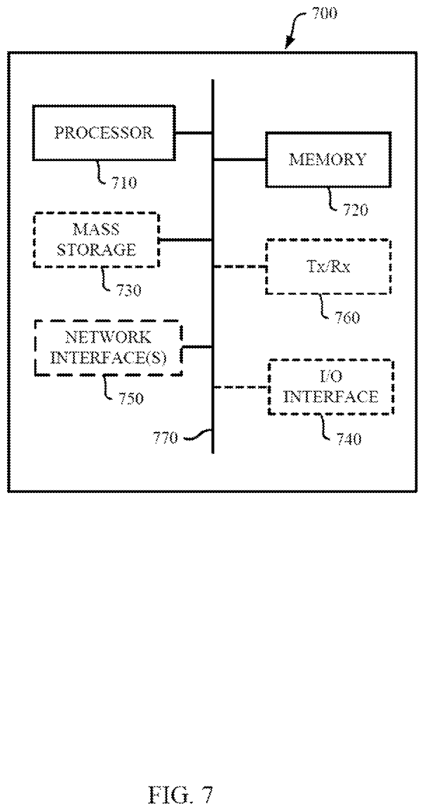

FIG. 7 illustrates an apparatus 700 that may perform any or all of operations of the above methods and features explicitly or implicitly described herein, according to different aspects of the present disclosure. For example, a computer equipped with network function may be configured as the apparatus 700. In some aspect, apparatus 700 can be a device that connects to the network infrastructure over a radio interface, such as a mobile phone, smart phone or other such device that may be classified as user equipment (UE). In some aspects, the apparatus 700 may be a Machine Type Communications (MTC) device (also referred to as a machine-to-machine (m2m) device), or another such device that may be categorized as a UE despite not providing a direct service to a user. According to an aspect, apparatus 700 may be a network entity involved in one or more operations or methods described herein. For example, apparatus 700 may be a vehicle user or user 110, an edge server 120, an identity server 130, one or more blockchain nodes, a service provider 140, and the like. In some aspects, apparatus 700 may be or configured used to implement one or more aspects described herein. For example, apparatus 700 may be configured to perform one or more methods according to one or more aspects described herein.

As shown, the apparatus 700 may include a processor 710, such as a Central Processing Unit (CPU) or specialized processors such as a Graphics Processing Unit (GPU) or other such processor unit, memory 720, non-transitory mass storage 730, input-output interface 740, network interface 750, and a transceiver 760, all of which are communicatively coupled via bi-directional bus 770. Transceiver 760 may include one or multiple antennas According to certain aspects, any or all of the depicted elements may be utilized, or only a subset of the elements. Further, apparatus 700 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 720 may include any type of non-transitory memory such as static random-access memory (SRAM), dynamic random-access memory (DRAM), synchronous DRAM (SDRAM), read-only memory (ROM), any combination of such, or the like. The mass storage element 730 may include any type of non-transitory storage device, such as a solid-state drive, hard disk drive, a magnetic disk drive, an optical disk drive, USB drive, or any computer program product configured to store data and machine executable program code. According to certain aspects, the memory 720 or mass storage 730 may have recorded thereon statements and instructions executable by the processor 710 for performing any of the aforementioned method operations described above.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology, or to structure some or all of its components in accordance with the system of the technology, or both.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, by an identity server (IS) from a user, a request for an identity credential, the request indicating:
an identifier (ID) of the user;
a commitment parameter, generated based on first two random values;
a parameter generated based on second two random values; and
a proof transcript indicating ownership of the first two random values;
generating, by the IS, a signature based on the commitment parameter and a random value; and
sending, by the IS to the user, the signature usable by the user to obtain the identity credential.

2. The method of claim 1, further comprising:
parsing, by the IS, the request to obtain the commitment parameter; and
verifying, by the IS, the ownership of the first two random values.

3. The method of claim 1, further comprising:
generating, by the IS, system parameters [symbol] ={p, [symbol] , H, H₁}, wherein: [symbol]
are a set of three cyclic multiplicative groups of a prime order p, wherein 2^{λ}≤p≤2^{λ+1}, along with a bilinear map e: [symbol] , wherein Γ={p, [symbol] , e} is generated via a type-3 pairing-group generator G and 1^{λ};
λ is a security parameter that represents a level of security; [symbol]
and [symbol] are denoted as [symbol] and [symbol] ; and
H and H₁ are hash functions based on: H:{0,1}*→ [symbol] and H₁: [symbol] .

4. The method of claim 1, further comprising:
generating, by the IS, a private key X and a public key (g, Y, \tilde{g}, \tilde{X}, \tilde{Y}), wherein
$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$
and (X, Y)=(g^{x}, g^{y}) and (\tilde{X}, \tilde{Y})=(\tilde{g}^{x}, \tilde{g}^{y}), wherein $ denotes that a value is randomly chosen from a group.

5. The method of claim 4, wherein the commitment parameter is generated according to C=g^{r}Y^{v}, wherein: C is the commitment parameter, v is a private key of the user and is generated according to
$$v {←}^{\$} {ℤ}_{p} ;$$
and r is used to randomize the commitment parameter and is generated according to
$$r {←}^{\$} {ℤ}_{p} .$$

6. The method of claim 4, wherein u is the random value and generated according to:
$$u {←}^{\$} {ℤ}_{p}$$
and the parameter is generated according to: T=at, wherein T is the parameter, and t and a are the second two random values and generated, respectively, according to:
$$t {←}^{\$} {ℤ}_{p} and a {←}^{\$} {ℤ}_{p} .$$

7. The method of claim 4, wherein the proof transcript is based on a non-interactive zero-knowledge proof.

8. The method of claim 7, wherein the proof transcript, (T_{C}, r′, v′), is generated as follows:
T_{C}=g^{ρ}^{ᵣ}Y^{ρ}^{ᵥ}, wherein ρᵣ, ρᵥ are randomly generated according to: ρᵣ,
$${ρ}_{v} {←}^{\$} {ℤ}_{p} ;$$
$${r}^{′} = {ρ}_{r} - cr ; \\ {v}^{′} = {ρ}_{v} - cv ; \\ and \\ c = {H}_{1} ( {T}_{C} ) .$$

9. A method comprising:
receiving, by a service provider (SP) from a user, a request to subscribe to a service, the request comprising:
an identifier (ID) of the user;
a parameter \tilde{Y}^{v}, wherein \tilde{Y} is a component of a public key of an identity server (IS), v is a random variable generated according to
$$v {←}^{\$} {ℤ}_{p ,}$$
and $ denotes that a value is randomly chosen from a group;
an identity credential of the user;
a random variable a generated according to
$$a {←}^{\$} {ℤ}_{p} ;$$
and
an indication of the service; and
generating, by the SP, a service credential, based on the identity credential of the user and the indication of the service.

10. The method of claim 9, further comprising:
parsing, by the SP, the request to obtain the identity credential of the user; and
verifying, by the SP, the identity credential of the user.

11. The method of claim 9, wherein the identity credential is verified according to: e(σ₁, \tilde{X}\tilde{Y}^{v})=e(σ₂, \tilde{g}), wherein:
σ₁ and σ₂ are components of the identity credential σ;
e is a bilinear map determined according to e: [symbol] ; [symbol]
are a set of three cyclic multiplicative groups of a prime order p, wherein 2^{λ}≤p≤2^{λ+1};
\tilde{g} and \tilde{X} are components of a public key, (g, Y, \tilde{g}, \tilde{X}, \tilde{Y}), of the IS, wherein
$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$
and (X, Y)=(g^{x}, g^{y}) and (\tilde{X}, \tilde{Y})=(\tilde{g}^{x}, \tilde{g}^{y}).

12. The method of claim 11, wherein the service credential Cₛ_{ᵢ} is a signature σᵢ generated according to:
$$( {σ}_{i , 1} , {σ}_{i , 2} ) = ( {σ}_{1}^{{t}_{i}} , {( {σ}_{2} {σ}_{1}^{{y}_{i} H ( {s}_{i} )} )}^{{t}_{i}} ) = ( {g}^{{ut}_{i}} , {g}^{{ut}_{i} ( x + yv + {y}_{i} H ( {s}_{i} ) )} ) ,$$
wherein:
σ_{i,1}, σ_{i,2} are components of the signature σᵢ;
yᵢ is a private key of the SP and is randomly generated according to
$${y}_{i} {←}^{\$} {ℤ}_{p} ;$$
tᵢ is a random variable generated according to
$${t}_{i} {←}^{\$} {ℤ}_{p} ;$$
H is a hash function and is based on: H:{0,1}*→ [symbol] ; and
u and v are random variables generated, respectively, according to
$$u {←}^{\$} {ℤ}_{p} and v {←}^{\$} {ℤ}_{p} .$$

13. The method of claim 12, further comprising:
generating, by the SP, a proof transcript using a non-interactive zero-knowledge (NIZK) proof to prove validity of the signature σᵢ; and
sending, by the SP to an identity server (IS), the proof transcript.

14. The method of claim 13, wherein the proof transcript comprises
$$( {T}_{{σ}_{i}} , {s}_{i}^{′} ) ,$$
the NIZK proof is based on NIZK{(sᵢ):e(σ_{i,1}, \tilde{X}\tilde{Y}^{v}\tilde{Y}ᵢ^{H(s}^{ᵢ}⁾)=e(σ_{i,2}, \tilde{g})}, and the generating the proof transcript comprises computing:
$${T}_{{σ}_{i}} = e {( {σ}_{i , 2} , {\tilde{Y}}_{i} )}^{{ρ}_{{s}_{i}}} ,$$
wherein ρₛ_{ᵢ} is a random variable generated according to
$${ρ}_{{s}_{i}} {←}^{\$} {ℤ}_{p} ,$$
and \tilde{Y}ᵢ is a public key of the SP and is generated according to: \tilde{Y}ᵢ=\tilde{g}^{y}^{ᵢ}, the SP providing the service indicated by the service sᵢ;
c=H₁(T_{σ}_{ᵢ}), wherein H₁ is another hash function and is based on H₁: [symbol] ; and
$${s}_{i}^{′} = {ρ}_{{s}_{i}} - c H ( {s}_{i} ) .$$

15. The method of claim 12, further comprising:
sending, by the SP to the IS, the ID of the user, the signature σᵢ and parameter Tᵢ, wherein Tᵢ=atᵢ, wherein a is a random value generated according to:
$$a {←}^{\$} {ℤ}_{p} .$$

16. A method comprising:
receiving, by an identity server (IS), a request message requesting to generate an anonymous credential for a user, the request message indicating:
an identifier (ID) of the user;
a signature, generated based on an identity credential of the user and is related to a service indicated via a service sᵢ; and
a parameter Tᵢ, wherein Tᵢ=atᵢ, wherein a and tᵢ are random values generated respectively according to:
$${t}_{i} {←}^{\$} {ℤ}_{p} , and a {←}^{\$} {ℤ}_{p} ,$$
$ denotes that a value is randomly chosen from a group;
verifying, by the IS, validity of the signature; and
generating, by the IS, the anonymous credential for the user based on the signature.

17. The method of claim 16, further comprising:
generating, by the IS, system parameters [symbol] ={p, [symbol] , H, H₁}, wherein: [symbol]
are a set of three cyclic multiplicative groups of a prime order p, wherein 2^{λ≤p≤}2^{λ+1}, along with a bilinear map e: [symbol] , wherein Γ={p, [symbol] , e} is generated via a type-3 pairing-group generator G and 1^{λ};
λ is a security parameter that represents a level of security; [symbol]
and [symbol] are denoted as [symbol] and [symbol] ;
H and H₁ are hash functions based on: H:{0,1}*→ [symbol] and H₁: [symbol] ; and
generating, by the IS, a private key X and a public key (g, Y, \tilde{g}, \tilde{X}, \tilde{Y}), wherein
$$g {←}^{\$} {𝔾}_{1}^{⋆} , \tilde{g} {←}^{\$} {𝔾}_{2}^{⋆} , ( x , y ) {←}^{\$} {ℤ}_{p}^{2}$$
and (X, Y)=(g^{x}, g^{y}) and (\tilde{X}, \tilde{Y})=(\tilde{g}^{x}, \tilde{g}^{y}).

18. The method of claim 17, wherein the verifying, by the IS, validity of the signature comprises: testing if
$$c = {H}_{1} ( e {( {σ}_{i , 1} , \tilde{Y} )}^{{{v}^{′} ( \frac{e ( {σ}_{i , 2} , \tilde{g} )}{e ( {σ}_{i , 1} , \tilde{X} {\tilde{Y}}^{v} )} )}^{c}} ) ,$$
wherein:
σ_{i,1}, σ_{i,2} are components of the signature σᵢ;
v′ is a component of a proof transcript of the user, wherein v′=ρᵥ−cv;
c=H₁(T_{C});
T_{C}=g^{ρ}^{ᵣ}Y^{ρ}^{ᵥ}, wherein ρᵣ, ρᵥ are randomly generated according to: ρᵣ,
$${ρ}_{v} {←}^{\$} {ℤ}_{p} ;$$
and
v is a private key of the user and a value randomly generated according to
$$v {←}^{\$} {ℤ}_{p} .$$

19. The method of claim 18, further comprising:
generating, by the IS, a parameter σᵢ′ based on the signature σᵢ according to:
$${σ}_{i}^{′} = ( {σ}_{i , 1} , {σ}_{i , 2}^{′} ) = ( {σ}_{i , 2}^{{}_{\frac{T}{{T}_{i}}}} , {σ}_{i , 2}^{\frac{T}{{T}_{i}}} ) = ( {g}^{ut} , {g}^{ut ( x + y + yv + {y}_{i} H ( {s}_{i} ) )} ) ;$$
and
storing, by the IS, the anonymous credential σ_{S} for service authentication;
wherein:
T=at, wherein t is a random value generated according to
$$t {←}^{\$} {ℤ}_{p} ;$$
u is a random variable generated according to
$$u {←}^{\$} {ℤ}_{p} ;$$
and
yᵢ is a private key of a service provider (SP) of the service and is randomly generated according to
$${y}_{i} {←}^{\$} {ℤ}_{p} .$$

20. The method of claim 19, wherein the generating, by the IS, the anonymous credential σ_{S} comprises: aggregating, by the IS, {σᵢ′}, i∈S, wherein S is a set of indices of services to which the user is subscribed, to generate the anonymous credential σ_{S} with a constant size, according to σ_{S}=(σ_{S,1}, σ_{S,2})=(σ_{i,1}′, Π_{i,i∈S}σ_{i,2}′)=(g^{ut}, g^{utΣ}^{_{i,i∈S}}^{(x+yv+y}^{ᵢ}^{H(s}^{ᵢ}⁾⁾).
